(19) United States
(12) Patent Application Publication
(10) Pub. No.: US 2009/0043064 A1
(43) Pub. Date: Feb. 12, 2009

(54) METAL COMPLEX, POLYMER COMPOUND, AND DEVICE CONTAINING IT

(75) Inventors: Nobuhiko Akino, Saitama (JP); Satoshi Mikami, Osaka (JP); Chizu Sekine, Ibaraki (JP)

Correspondence Address: SUGHRUE MION, PLLC, 2100 PENNSYLVANIA AVENUE, N.W., SUITE 800, WASHINGTON, DC, 20037, US

(73) Assignees: SUMITOMO CHEMICAL COMPANY, LIMITED, Chuo-ku, Tokyo (JP); SUMATION CO., LTD., Chuo-ku, Tokyo (JP)

(21) Appl. No.: 12/279,739

(22) PCT Filed: Feb. 21, 2007
(86) PCT No.: PCT/JP2007/053697

§ 371 Date: Sep. 5, 2008

(30) Foreign Application Priority Data
Feb. 22, 2006 (JP) 2006-044990
Dec. 14, 2006 (JP) 2006-336653

(51) Int. Cl. C08F 132/08; C07F 15/00

(52) U.S. Cl. 526/280; 546/4

(57) ABSTRACT

A metal complex having a structure of the following general formula (1):

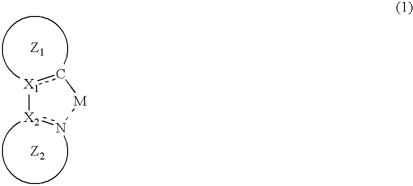

(wherein, X₁ and X₂ represent independently a carbon atom or nitrogen atom. Bonds represented by X₁ [symbol] C and X₂ [symbol] N are a single bond or double bond. M represents a transition metal atom. A dihedral angle defined by a plane containing a structure represented by C [symbol] X₁—X₂ and a plane containing a structure represented by X₁—X₂ [symbol] N is 9° to 16°, and the proportion of the sum of squares of orbital coefficients of the outermost d orbital of the metal atom M, in the highest occupied molecular orbital of the metal complex, occupying with respect to the sum of squares of all atom orbital coefficients, is divided by an energy difference S₁−T₁ between the lowest excitation singlet energy S₁ and the lowest excitation triplet energy T₁ of the metal complex, to give a value of 200 to 600%/eV.).

### TECHNICAL FIELD

The present invention relates to a metal complex, a polymer compound containing a residue of the above-described metal complex, and a device containing it.

### BACKGROUND ART

Metal complexes showing light emission from the triplet excited state as a light emitting material to be used in a light emitting layer of an electroluminescence device can be expected to have higher light emission efficiency than fluorescent materials showing light emission from the singlet excited state. The reason for this is that excitons generated by recombination of carriers include theoretically 25% singlet excitons and remaining 75% triplet excitons That is, the upper limit is theoretically 25% in the case of use of light emission from the singlet excited state (namely, fluorescence), while 3-fold efficiency can be expected theoretically in the case of use of light emission from the triplet excited state (namely, phosphorescence). Further, 4-fold efficiency can be expected theoretically if intersystem crossing from 25% the singlet excited state to the triplet excited state occurs efficiently, from the standpoint of relative relation of energy.

In general, light emission from the triplet excited state (namely, phosphorescence) in occurrence of transition from the triplet excited state to the singlet ground state is forbidden transition since it is accompanied by spin inversion. However, metal complexes containing a heavy atom metal are known to include compounds showing light emission, since this forbidden transition is allowed by a heavy atom effect. For example, as metal complexes showing light emission from the triplet excited state, an orthometalated complex containing iridium as a central metal (Ir(ppy)₃: Tris-Ortho-Metalated Complex of Iridium (III) with 2-Phenylpyridine) is known to show green light emission with high efficiency, and there is also reported a multi-layer electroluminescence device obtained by combining this with a low molecular weight host (APPLIED PHYSICS LETTERS, Vol. 75, No. 1, p. 4 (1999)).

However, for practical use of electroluminescence devices using a metal complex, and the like, it is necessary that light emission efficiency is high and stability is excellent in all three primary colors.

Then, it is desired to develop a metal complex excellent in light emission efficiency and stability, particularly in a red light emission region or blue light emission region.

### DISCLOSURE OF THE INVENTION

An object of the present invention is to provide a metal complex excellent in light emission efficiency and stability.

The present inventors have intensively studied and resultantly found that if a metal complex having a specific structure and having specific quantum-chemical natures is used, light emission efficiency and stability of an electroluminescence device are excellent, leading to completion of the present invention.

That is, the present invention provides, firstly, a metal complex having a structure of the following general formula (1):

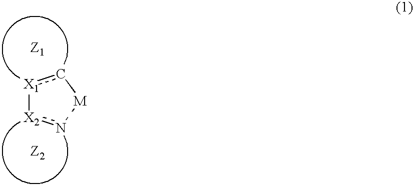

(wherein, X₁ and X₂ represent each independently a carbon atom or nitrogen atom. A bond of the following formula:

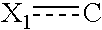

and a bond of the following formula:

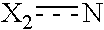

represent each independently a single bond or double bond.
M represents a transition metal atom. Z₁ ring represents a cyclic structure containing a bond of the following formula:

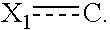

Z₂ ring represents a cyclic structure containing a bond of the following formula:

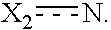

), wherein

a dihedral angle defined by a plane containing a structure of the following formula:

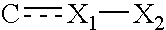

and a plane containing a structure of the following formula:

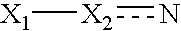

is 9° to 16°, and the proportion (%) of the sum of squares of orbital coefficients of the outermost d orbital of the metal atom M, in the highest occupied molecular orbital of the metal complex, occupying with respect to the sum of squares of all atom orbital coefficients, is divided by an energy difference S₁−T₁ between the lowest excitation singlet energy S₁ (eV) and the lowest excitation triplet energy T₁ (eV) of the metal complex, to give a value (hereinafter, referred to as “d orbital parameter”) of 200 to 600%/eV.

The present invention provides, secondly, a metal complex having a structure of the following general formula (1):

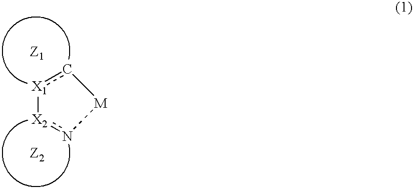

(wherein, X₁ and X₂ represent each independently a carbon atom or nitrogen atom. A bond of the following formula:

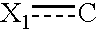

and a bond of the following formula:

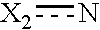

represent each independently a single bond or double bond.
M represents a transition metal atom. Z₁ ring represents a cyclic structure containing a bond of the following formula:

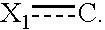

Z₂ ring represents a cyclic structure containing a bond of the following formula:

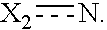

), wherein

the above-described Z₁ ring has a structure of the following general formula (2):

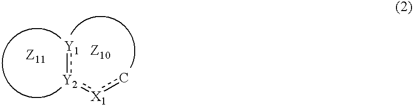

(wherein, X₁, Y₁ and Y₂ represent each independently a carbon atom or nitrogen atom. A bond of the following formula:

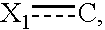

a bond of the following formula:

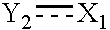

and a bond of the following formula:

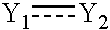

represent each independently a single bond or double bond. Z₁₀ ring represents a cyclic structure containing a structure of the following formula:

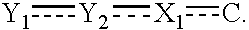

Z₁₁ ring represents a cyclic structure constituted of single bonds excepting the bond of the following formula:

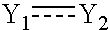

or the above-described Z₂ ring has a structure of the following general formula (3):

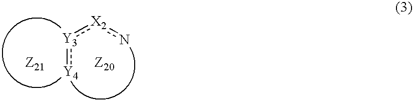

(wherein, X₂, Y₃ and Y₄ represent each independently a carbon atom or nitrogen atom. A bond of the following formula:

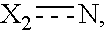

a bond of the following formula:

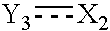

and a bond of the following formula:

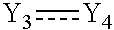

represent each independently a single bond or double bond. Z₂₀ represents a cyclic structure containing a structure of the following formula:

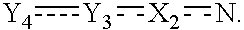

Z₂₁ ring represents a cyclic structure constituted of single bonds excepting the bond of the following formula:

Y₃ [symbol] Y₄.), or, the above-described Z₁ ring has a structure of the general formula (2) and the above-described Z₂ ring has a structure of the general formula (3).

The present invention provides, thirdly, a metal complex having a structure of the following general formula (5):

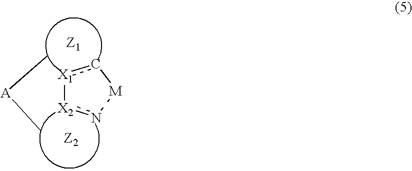

(wherein, X₁ and X₂ represent each independently a carbon

atom or nitrogen atom. A bond of the following formula:

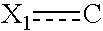

and a bond of the following formula:

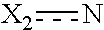

represent each independently a single bond or double bond.
M represents a transition metal atom. Z₁ ring represents a cyclic structure containing a bond of the following formula:

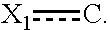

Z₂ ring represents a cyclic structure containing a bond of the following formula:

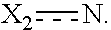

A represents a connecting group connected to one atom in the Z₁ ring and to one atom in the Z₂ ring, and the connecting group contains 2 to 6 groups selected from groups represented by —C(R⁵⁰¹)(R⁵⁰²)—, —N(R⁵⁰³)—, —P(R⁵⁰⁴)—, —P(═O)(R⁵⁰⁷)—, —Si(R⁵⁰⁵)(R⁵⁰⁶)— and —SO₂—

R⁵⁰¹ to R⁵⁰⁷ represent each independently a hydrogen atom, alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, silyloxy group, substituted silyloxy group, monovalent heterocyclic group or halogen atom.).

The present invention provides, fourthly, a polymer compound comprising in its molecule a residue of the above-described metal complex.

### MODE FOR CARRYING OUT THE INVENTION

The present invention will be explained in detail below.

### <Metal Complex>

First, the metal complexes of the present invention (the following first to third metal complexes) are described.

### —First Metal Complex—

The first metal complex of the present invention has a structure of the above-described general formula (1), and satisfies simultaneously

condition A: the above-described dihedral angle (hereinafter, referred to as “dihedral angle in ligand” in some cases) is 9° to 16°, and

condition B: the above-described d orbital parameter is 200 to 600%/eV.

When the above-described dihedral angle is less than 9°, suppression of motion of ligands becomes insufficient in some cases, and when over 16°, twisting of ligands becomes too significant to lose the stability as a multidentate ligand, in some cases. This dihedral angle is correlated with the motion of a ligand, resultantly, an effect on the stability of a metal complex is envisaged, thus, it is preferably 9° to 14°, more preferably 9° to 12°, particularly preferably 9° to 11°.

When the above-described d orbital parameter is less than 200%/eV, light emission efficiency may lower owing to a little contribution of the d orbital of a central metal or large energy difference (S₁−T₁), and when over 600%/eV, efficiency may lower owing to small energy difference (S₁−T₁). This d orbital parameter is preferably 200 to 500%/eV, more preferably 200 to 400%/eV, particularly preferably 200 to 300%/eV, since it is thought to be a parameter correlated with the light emission efficiency of a metal complex.

In the present specification, the “ligand” means a portion excepting metal atom M, for example, in a structure of the above-described general formula (1) or (5) (including also lower concepts such as a structure of the general formula (4-1) or general formula (4-2) described later, and the like). In the present specification, the “dihedral angle” means an angle calculated based on a metal complex in the ground state. In the present specification, the dihedral angle is calculated based on an optimized structure in the ground state of a metal complex obtained by a computational scientific means (namely, a structure at which the production energy of the metal complex is minimum). Specifically, in the case of a metal complex containing two or more of the same ligands as represented by M(L)₃ (here, M represents the same meaning as described above, and L represents a ligand), the dihedral angle is defined as an average value of dihedral angles of ligands. In the case of containing two or more of different ligands such as M (L)₂(L₂)₁ (wherein, M represents the same meaning as described above, L and L₂ represent mutually different ligands), it is necessary that any of mutually different ligands (for example, any of a value of the dihedral angle of the ligand L and a value of the dihedral angle of the ligand L₂, in the above-described formula) satisfies the above-described dihedral angle range. In the case of containing two or more of the same ligands (for example, the ligand L, in the above-described formula), the dihedral angle of the same ligand (for example, the ligand L, in the above-described formula) is an average value of dihedral angles of ligands. In the present specification, the d orbital parameter is calculated by a computational scientific methods.

As the computational scientific methods to be used for calculating the above-described dihedral angle and d orbital parameter, known are a molecular orbital method, density functional theory and the like based on semiempirical methods and nonempirical methods. For optimizing the structure of a metal complex, for example, a Hartree-Fock (HF) method or density functional theory may be used.

In the present specification, by performing a density functional theory of B3LYP level using a quantum chemical calculation program Gaussian03, the structure of the ground state of a metal complex was optimized and the dihedral angle in ligand was calculated, and simultaneously, the population analysis was carried out of the molecular orbital of a metal complex in the optimized structure; thus, the proportion (%) of the sum of squares of orbital coefficients of the outermost d orbital of a metal atom (namely, central metal atom) M, in the highest occupied molecular orbital (HOMO) of the metal complex, occupying with respect to the sum of squares of all atom orbital coefficients, was calculated. In this procedure, LANL2DZ was used for a metal atom (namely, central metal atom), and 6-31 G* was used for other atoms than this, as the basis function. The population analysis in a metal complex was carried out as described later. That is, the proportion ρ_{d}^{HOMO}(%) of the sum of squares of orbital coefficients of the outermost d orbital of a metal atom M, in the HOMO of the metal complex, occupying with respect to the sum of squares of all atom orbital coefficients, was calculated according to the following formula:

ρ_{d}^{HOMO}(%)=S_{id}(C_{id}^{HOMO})²/Sₙ(Cₙ^{HOMO})²×100(%)

In the formula, id and n represent the number of the d orbitals and the number of all atom orbitals, respectively, to be taken into consideration in the above-described calculation methods and basis function. C_{id}^{HOMO} and Cₙ^{HOMO} represent atomic orbital coefficients represented by id and n, respectively, in HOMO. The lowest excited singlet energy S₁ (eV), the lowest excited triplet energy T₁ (eV) and the energy difference S₁−T₁ (eV) thereof are calculated using a time-dependent density functional theory of B3LYP level using the same basis function as described above, after optimization of structure.

In general, since light emission from the triplet excited state (namely, phosphorescence) in occurrence of transition from the triplet excited state to the singlet ground state is forbidden transition, the lifetime of the triplet excited state is longer by several order or more as compared with the usual lifetime of the singlet state. It results in staying for a longer period of time at the exited state which is an unstable state with high energy. Therefore, a deactivation process via a reaction with a compound present around occurs and a lot of metal complexes in the triplet excited state are present to give a saturated state, thereby leading to a tendency of a phenomenon known as so-called triplet-triplet annihilation, and an influence can also be exerted on efficiency of phosphorescence emission. That is, for stable light emission with high efficiency, preferable is a metal complex showing short lifetime of the triplet excited state, which is liable to cause a release of forbidden transition.

A ligand constituting a metal complex exerts an influence on light emission color, light emission intensity, light emission efficiency and the like of a metal complex. Therefore, preferable as the metal complex are those constituted of a ligand having a structure which minimizes an energy deactivation process in the ligand. For minimizing an energy deactivation process, it is preferable that a ligand is made more rigid to lower the motion of the ligand, thereby improving the durability of a metal complex. From the standpoint described above, preferable as the metal complex are those having a structure suppressing motion of cyclic structures constituting a ligand (specifically, Z₁ ring and Z₂ ring), that is, those having a structure showing high energy barrier against motion. Further, from the standpoints of light emission efficiency and stability, it is preferable to shield a metal atom (namely, central metal atom) at least partially by a ligand.

The metal atom M as a central metal of a metal complex is a transition metal atom. A transition metal atom manifests a spin-orbit interaction, and is capable of causing intersystem crossing between the singlet state and the triplet state. Preferable are metal atoms such as ruthenium, rhodium, palladium, osmium, iridium and platinum, preferably osmium, iridium and platinum, further preferably iridium and platinum, particularly preferably iridium.

The “cyclic structure” represented by ring Z₁ in the above-described general formula (1) means an aromatic ring, a non-aromatic ring, a moiety obtained by partial or total substitution of hydrogen atoms in these rings, or the like, and may be a monocyclic ring or condensed ring. Specifically mentioned are aromatic hydrocarbon rings, heteroaromatic rings and alicyclic hydrocarbons, and rings obtained by condensation of some of these rings, and rings obtained by partial or total substitution of hydrogen atoms in these rings, and the like are included, and preferable are those containing a structure of the above-described general formula (2).

As the monocyclic aromatic hydrocarbon ring, for example, benzene is mentioned. Examples of the condensed aromatic hydrocarbon ring include naphthalene, anthracene, phenanthrene and the like. Examples of the monocyclic heteroaromatic ring include pyridine, pyrimidine, pyridazine and the like, and examples of the condensed heteroaromatic ring include quinoxaline, phenanthroline, carbazole, dibenzofuran, dibenzothiophene, dibenzosilole and the like. Examples of the alicyclic hydrocarbon ring include cyclobutane, cyclopentane, cyclohexyl and the like. As the other condensed ring structures, tetralin, tetrahydro-isoquinoline and the like are mentioned.

The ring Z₁ in the above-described general formula (1) may have a cyclic structure containing C (carbon atom) and X₁ (carbon atom or nitrogen atom), and though elements constituting this cyclic structure are not particularly restricted, preferable is a case constituted of elements selected from the group consisting of a carbon atom, nitrogen atom, oxygen atom, sulfur atom, phosphorus atom and silicon atom, more preferable is a case constituted of elements selected from the group consisting of a carbon atom, nitrogen atom, oxygen atom and sulfur atom, further preferable is a case constituted of a carbon atom and nitrogen atom. The number of elements constituting the cyclic structure is not particularly restricted providing the cyclic structure can be coordinated at the central metal M, and preferably 5 or more, more preferably 6 or more.

All or part of hydrogen atoms in the cyclic structure may be substituted each independently by a halogen atom, alkyl group, alkoxy group, alkylthio group, aryl group, aryloxy group, arylthio group, arylalkyl group, arylalkoxy group, arylalkylthio group, acyl group, acyloxy group, amide group, acid imide group, imine residue, substituted amino group, substituted silyl group, substituted silyloxy group, substituted silylthio group, substituted silylamino group, monovalent heterocyclic group, heteroaryloxy group, heteroarylthio group, arylalkenyl group, arylethynyl group, substituted carboxyl group or cyano group.

The “cyclic structure” represented by ring Z₂ in the above-described general formula (1) means an aromatic ring, a non-aromatic ring, a moiety obtained by partial or total substitution of hydrogen atoms in these rings, or the like, and may be a monocyclic ring or condensed ring. Specifically mentioned are aromatic hydrocarbon rings, heteroaromatic rings and alicyclic hydrocarbons, and rings obtained by condensation of some of these rings, and rings obtained by partial or total substitution of hydrogen atoms in these rings, and the like are included, and preferable are those containing a structure of the above-described general formula (3).

As specific examples of the aromatic hydrocarbon rings, heteroaromatic rings, alicyclic hydrocarbons and the like, structures described above are mentioned.

The ring Z₂ in the above-described general formula (1) may have a cyclic structure containing N (nitrogen atom) and X₂ (carbon atom or nitrogen atom), and though elements constituting this cyclic structure are not particularly restricted, preferable is a case constituted of elements selected from the group consisting of a carbon atom, nitrogen atom, oxygen atom, sulfur atom, phosphorus atom and silicon atom, more preferable is a case constituted of elements selected from the group consisting of a carbon atom, nitrogen atom, oxygen atom and sulfur atom, further preferable is a case constituted of a carbon atom and nitrogen atom. The number of elements constituting the cyclic structure is not particularly restricted providing the cyclic structure can be coordinated at the central metal M, and preferably 5 or more, more preferably 6 or more.

All or part of hydrogen atoms in the cyclic structure may be substituted each independently by a halogen atom, alkyl group, alkoxy group, alkylthio group, aryl group, aryloxy group, arylthio group, arylalkyl group, arylalkoxy group, arylalkylthio group, acyl group, acyloxy group, amide group, acid imide group, imine residue, substituted amino group, substituted silyl group, substituted silyloxy group, substituted silylthio group, substituted silylamino group, monovalent heterocyclic group, heteroaryloxy group, heteroarylthio group, arylalkenyl group, arylethynyl group, substituted carboxyl group or cyano group.

In preferable embodiments of the present invention, the above-described Z₁ ring has a structure of the above-described general formula (2) or the above-described Z₂ ring has a structure of the above-described general formula (3), or the above-described Z₁ ring has a structure of the above-described general formula (2) and the above-described Z₂ ring has a structure of the above-described general formula (3).

Z₁₀ in the above-described general formula (2) is not particularly restricted providing it has a cyclic structure, and usually a 5-membered ring or 6-membered ring. The “cyclic structure” represented by Z₁₀ in the above-described general formula (2) means an unsubstituted or substituted aromatic ring, an unsubstituted or substituted non-aromatic ring, or the like, and specifically means, for example, an unsubstituted or substituted benzene ring, an unsubstituted or substituted hetero ring, an unsubstituted or substituted alicyclic hydrocarbon, a ring obtained by condensation of some of these rings, or the like.

The “cyclic structure” represented by Z₁₁ in the above-described general formula (2) means a structure constituted of single bonds excepting a bond of the following formula:

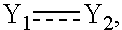

more specifically, a structure in which all atoms excepting Y₁ and Y₂ are connected by single bonds.

With respect to the cyclic structure represented by Z₁₁, though species of atoms constituting the cyclic structure are not particularly restricted providing Y₁ and Y₂ represent each independently a carbon atom or nitrogen atom and the above-described conditions are satisfied, preferable is a case constituted of elements selected from the group consisting of a carbon atom, nitrogen atom, oxygen atom, sulfur atom, phosphorus atom and silicon atom, more preferable is a case constituted of elements selected from the group consisting of a carbon atom, nitrogen atom, oxygen atom and sulfur atom, further preferable is a case constituted of a carbon atom and nitrogen atom.

As the structure of the above-described general formula (2), for example,

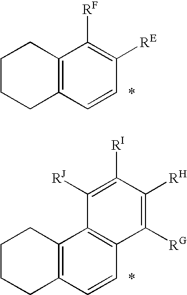

(wherein, * represents a site to be connected to a transition metal atom M. R^{E}, R^{F}, R^{G}, R^{H}, R^{I} and R^{J} represent each independently a hydrogen atom, halogen atom, alkyl group, alkoxy group, alkylthio group, aryl group, aryloxy group, arylthio group, arylalkyl group, arylalkoxy group, arylalkylthio group, acyl group, acyloxy group, amide group, acid imide group, imine residue, substituted amino group, substituted silyl group, substituted silyloxy group, substituted silylthio group, substituted silylamino group, monovalent heterocyclic group, heteroaryloxy group, heteroarylthio group, arylalkenyl group, arylethynyl group, substituted carboxyl group or cyano group, alternatively, R^{E} and R^{F}, R^{G} and R^{H}, R^{H} and R^{I}, or R^{I} and R^{J} may be connected to form an aromatic ring. It is preferable that R^{E} and R^{G} represent each independently a hydrogen atom or fluorine atom, and it is preferable that R^{F}, R^{H}, R^{I} and R^{J} represent each independently a hydrogen atom or halogen atom, alkyl group, alkoxy group, aryl group or monovalent heterocyclic group.) and the like are mentioned.

Z₂₀ in the above-described general formula (3) is not particularly restricted providing it has a cyclic structure, and usually a 5-membered ring or 6-membered ring. The “cyclic structure” represented by Z₂₀ in the above-described general formula (3) means an unsubstituted or substituted aromatic ring, an unsubstituted or substituted non-aromatic ring, or the like, and specifically means, for example, an unsubstituted or substituted benzene ring, an unsubstituted or substituted hetero ring, an unsubstituted or substituted alicyclic hydrocarbon, a ring obtained by condensation of some of these rings, or the like.

The “cyclic structure” represented by Z₂₁ in the above-described general formula (3) means a structure constituted of single bonds excepting a bond of the following formula:

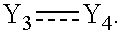

With respect to the cyclic structure represented by Z₂₁, though species of atoms constituting the cyclic structure are not particularly restricted providing Y₃ and Y₄ represent each independently a carbon atom or nitrogen atom and the above-described conditions are satisfied, preferable is a case constituted of elements selected from a carbon atom, nitrogen atom, oxygen atom, sulfur atom, phosphorus atom and silicon atom, more preferable is a case constituted of elements selected from a carbon atom, nitrogen atom, oxygen atom and sulfur atom, further preferable is a case constituted of a carbon atom and nitrogen atom.

As the structure of the above-described general formula (3), for example,

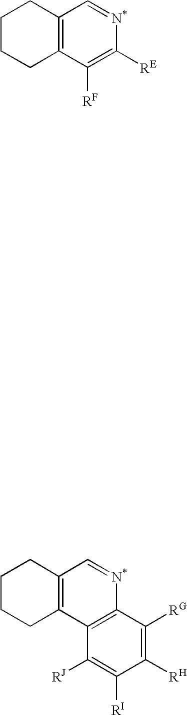

(wherein, * represents a site to be connected to a transition metal atom M. R^{E} to R^{J} represent each independently the same meaning as described above. R^{E} and R^{F}, R^{G} and R^{H}, R^{H} and R^{I}, or R^{I} and R^{J} may be connected to form an aromatic ring.) and the like are mentioned.

As the structure of the above-described general formula (1), those of the following general formula (4-1) and the following general formula (4-2):

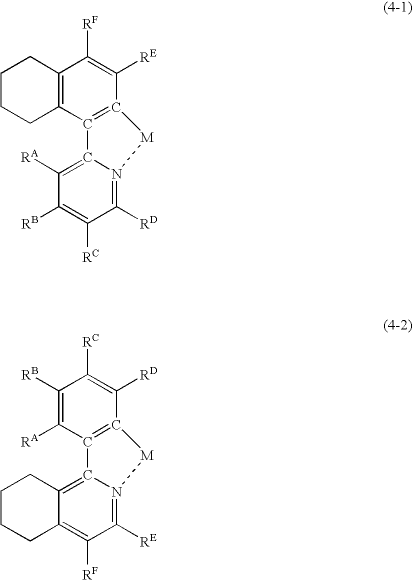

(wherein, M is as described above, R^{A}, R^{B}, R^{C}, R^{D}, R^{E} and RF represent each independently a hydrogen atom, halogen atom, alkyl group, alkoxy group, alkylthio group, aryl group, aryloxy group, arylthio group, arylalkyl group, arylalkoxy group, arylalkylthio group, acyl group, acyloxy group, amide group, acid imide group, imine residue, substituted amino group, substituted silyl group, substituted silyloxy group, substituted silylthio group, substituted silylamino group, monovalent heterocyclic group, heteroaryloxy group, heteroarylthio group, arylalkenyl group, arylethynyl group, substituted carboxyl group or cyano group, alternatively, at least one combination selected from the group consisting of R^{A} and R^{B}, R^{B} and R^{C}, R^{C} and R^{D}, and R^{E} and R^{F} may bind to form an aromatic ring. Further, it is preferable that R^{A}, R^{D} and R^{E} represent each independently a hydrogen atom or fluorine atom. It is preferable that R^{B} and R^{C} represent each independently a hydrogen atom or halogen atom, alkyl group, alkoxy group, aryl group or monovalent heterocyclic group.) are preferable.

Additionally, as the structure of the above-described general formula (1), for example, those of the following general formulae:

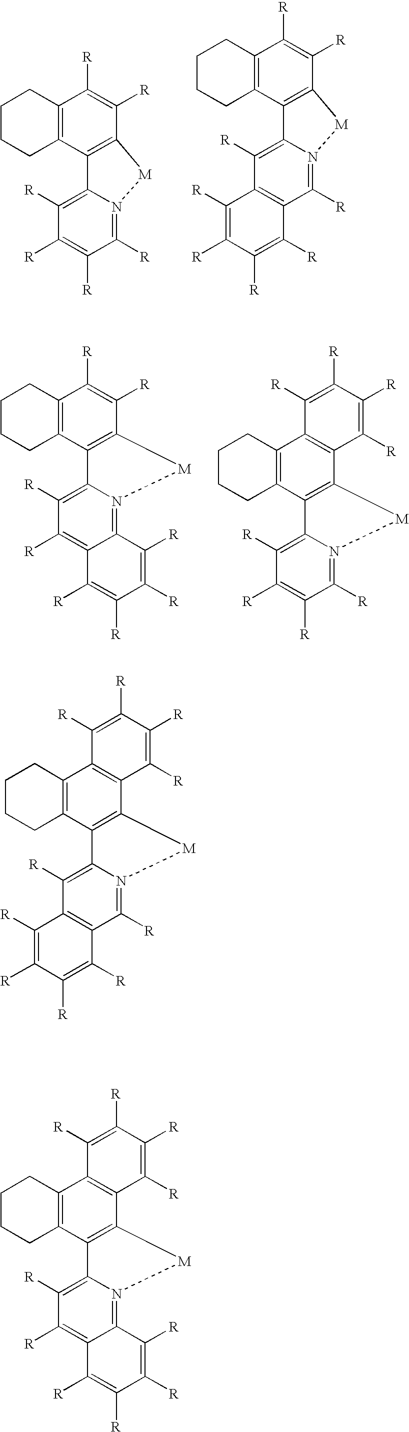

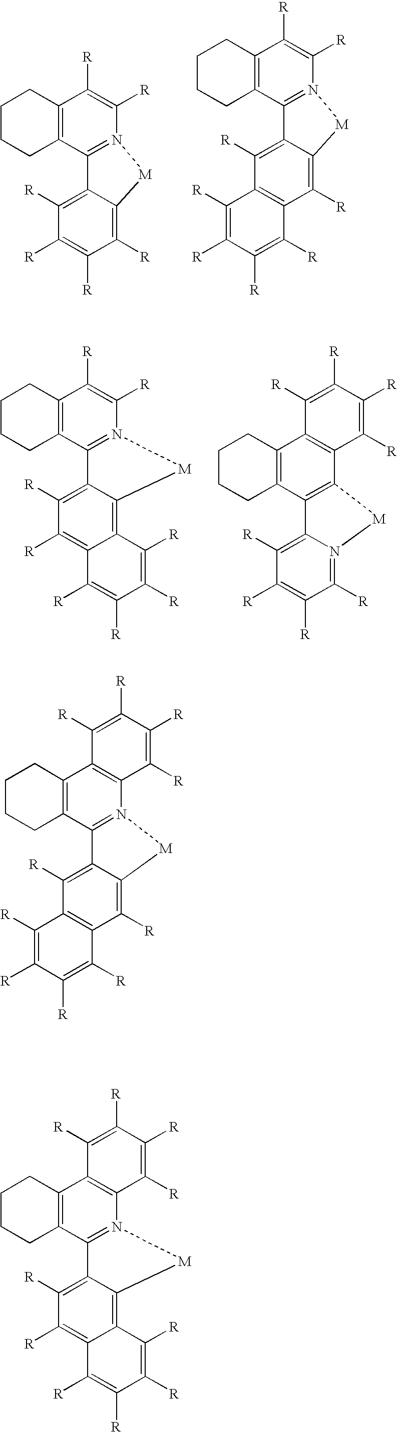

(wherein, M is as described above, Rs represent each independently a hydrogen atom, halogen atom, alkyl group, alkoxy group, alkylthio group, aryl group, aryloxy group, arylthio group, arylalkyl group, arylalkoxy group, arylalkylthio group, acyl group, acyloxy group, amide group, acid imide group, imine residue, substituted amino group, substituted silyl group, substituted silyloxy group, substituted silylthio group, substituted silylamino group, monovalent heterocyclic group, heteroaryloxy group, heteroarylthio group, arylalkenyl group, arylethynyl group, substituted carboxyl group or cyano group; alternatively, adjacent Rs may bind to form an aromatic ring.) and the like are mentioned. Of them, those of the above-described general formula (4-1) or the above-described general formula (4-2) are particularly preferable.

Specific examples of the first metal complex of the present invention having a structure of the above-described general formula (1) include those of the following general formulae:

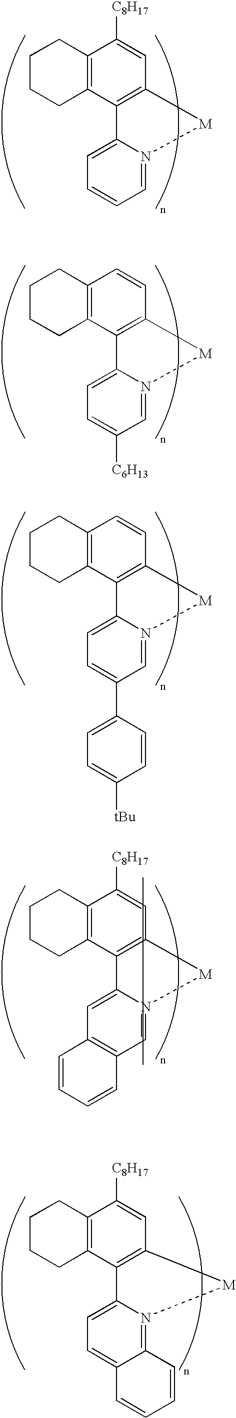

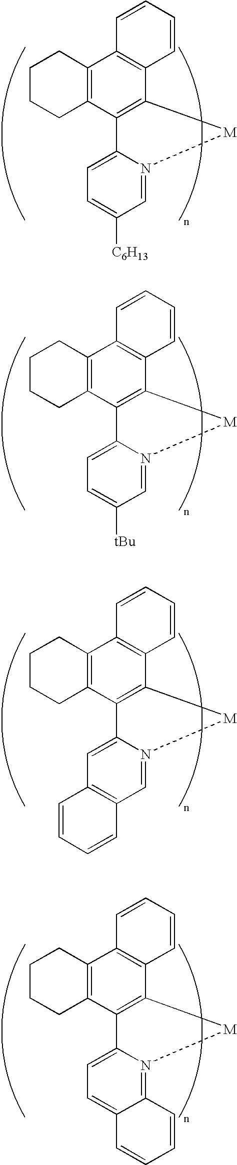

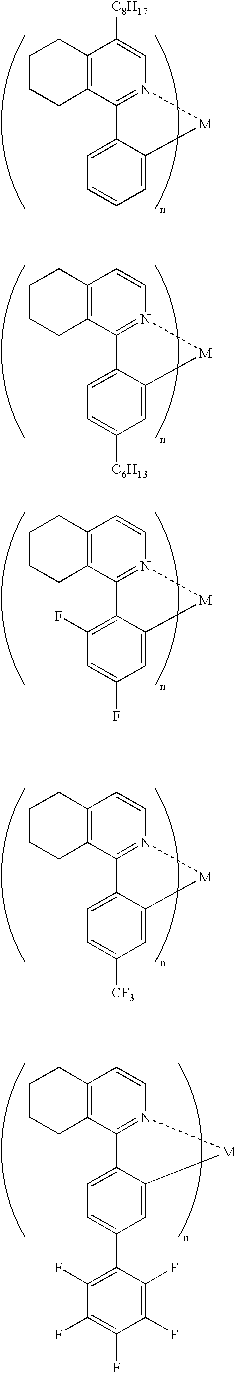

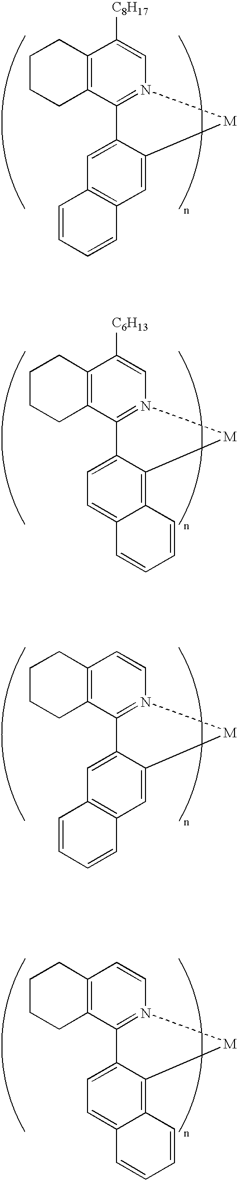

(wherein, M is as described above, n is an integer determined depending on the kind of a metal atom M.) and the like. Of them, those having a structure of the above-described general formula (4-1) or the above-described general formula (4-2) are preferable.

In the above-described formulae, n is 3 when M is rhodium or iridium, and 2 when M is palladium or platinum, for rendering a metal complex electrically neutral.

These specific examples are those represented by M (L)ₙ (wherein, M represents the same meaning as described above, L is a ligand, and n=2 or 3.), and the first metal complex of the present invention may also be constituted of different ligands, as represented by M(L)ₘ₁(L₂)ₘ₂, M(L)(L₂)(L₃) (wherein, M and L represent the same meaning as described above, L, L₂ and L₃ are mutually different ligands, and m₁ and m₂ represent independently 1 or 2, m₁+m₂=2 or 3.).

When M(L) has a structure of the above-described general formula (1), L₂ and L₃ are not particularly restricted. Provided that the property of the metal complex of the present invention is not deteriorated, L₂ and L₃ may be any ligand, and for example, the following monodentate ligands, bidentate ligands and the like are mentioned. Examples of the monodentate ligand include an alkynyl group, aryloxy group, amino group, silyl group, acyl group, alkenyl group, alkyl group, alkoxy group, alkylthio group, arylthio group, enolate group, amide group, hydrogen atom, alkyl group, aryl group, hetero ring ligand, carboxyl group, amide group, imide group, alkoxy group, alkylmercapto group, carbonyl ligand, alkene ligand, alkyne ligand, amine ligand, imine ligand, nitrile ligand, isonitrile ligand, phosphine ligand, phosphine oxide ligand, phosphite ligand, ether ligand, sulfone ligand, sulfoxide ligand, sulfide ligand and the like. Any ligand may be substituted with a halogen atom such as a fluorine atom, chlorine atom and the like. The bidentate ligand is not particularly restricted, and for example, ligands as shown below are illustrated.

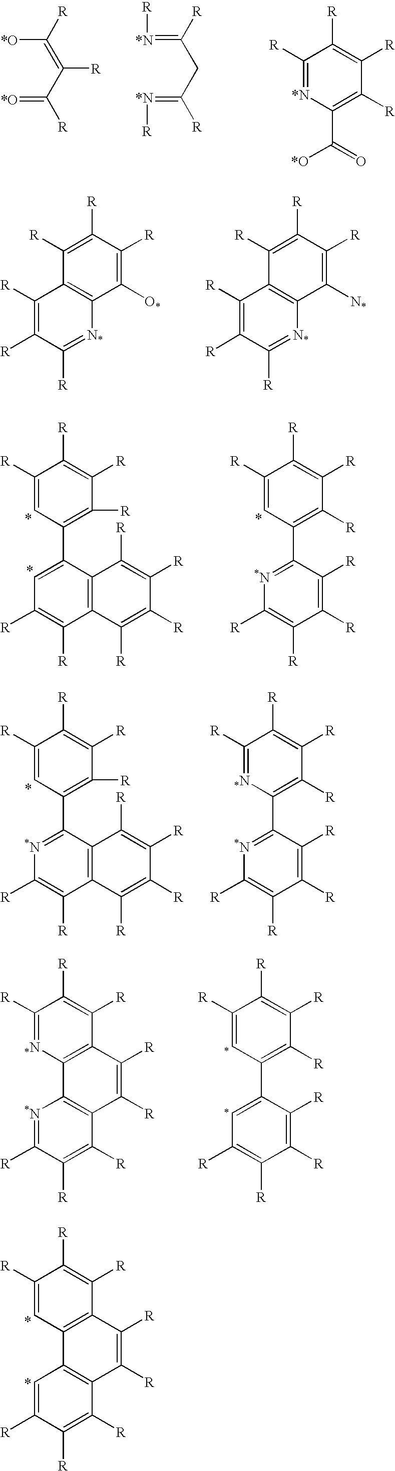

(in the figure, * represents a site to be connected to a transition metal atom M, and Rs represent each independently a hydrogen atom, halogen atom, alkyl group, alkoxy group, alkylthio group, aryl group, aryloxy group, arylthio group, arylalkyl group, arylalkoxy group, arylalkylthio group, acyl group, acyloxy group, amide group, acid imide group, imine residue, substituted amino group, substituted silyl group, substituted silyloxy group, substituted silylthio group, substituted silylamino group, monovalent heterocyclic group, heteroaryloxy group, heteroarylthio group, arylalkenyl group, arylethynyl group, substituted carboxyl group or cyano group; alternatively, adjacent Rs may be connected to form an aromatic ring.).

The cyclic structure (for example, Z₁ ring, Z₂ ring or the like) contained in a ligand constituting a metal complex of the present invention optionally have a substituent. The substituent includes a halogen atom, alkyl group, alkoxy group, alkylthio group, aryl group, aryloxy group, arylthio group, arylalkyl group, arylalkoxy group, arylalkylthio group, acyl group, acyloxy group, amide group, acid imide group, imine residue, substituted amino group, substituted silyl group, substituted silyloxy group, substituted silylthio group, substituted silylamino group, monovalent heterocyclic group, heteroaryloxy group, heteroarylthio group, arylalkenyl group, arylethynyl group, substituted carboxyl group, cyano group and the like. When two or more substituents are present on the cyclic structure, they may be the same or different.

Examples of the halogen atom include a fluorine atom, chlorine atom, bromine atom, iodine atom and the like.

The alkyl group may be linear, branched or cyclic. The carbon number thereof is usually about from 1 to 10, preferably 3 to 10. Specifically, a methyl group, ethyl group, propyl group, i-propyl group, butyl group, i-butyl group, t-butyl group, pentyl group, hexyl group, cyclohexyl group, heptyl group, octyl group, 2-ethylhexyl group, nonyl group, decyl group, 3,7-dimethyloctyl group, lauryl group, trifluoromethyl group, pentafluoroethyl group, perfluorobutyl group, perfluorohexyl group, perfluorooctyl group and the like are mentioned, and preferable are a pentyl group, hexyl group, octyl group, 2-ethylhexyl group, decyl group and 3,7-dimethyloctyl group.

The alkoxy group may be linear, branched or cyclic. The carbon number thereof is usually about from 1 to 10, preferably 3 to 10. Specifically, a methoxy group, ethoxy group, propyloxy group, i-propyloxy group, butoxy group, i-butoxy group, t-butoxy group, pentyloxy group, hexyloxy group, cyclohexyloxy group, heptyloxy group, octyloxy group, 2-ethylhexyloxy group, nonyloxy group, decyloxy group, 3,7-dimethyloctyloxy group, lauryloxy group, trifluoromethoxy group, pentafluoroethoxy group, perfluorobutoxy group, perfluorohexyl group, perfluorooctyl group, methoxymethyloxy group, 2-methoxyethyloxy group and the like are mentioned, and preferable are a pentyloxy group, hexyloxy group, octyloxy group, 2-ethylhexyloxy group, decyloxy group and 3,7-dimethyloctyloxy group.

The alkylthio group may be linear, branched or cyclic. The carbon number thereof is usually about from 1 to 10, preferably 3 to 10. Specifically, a methylthio group, ethylthio group, propylthio group, i-propylthio group, butylthio group, i-butylthio group, t-butylthio group, pentylthio group, hexylthio group, cyclohexylthio group, heptylthio group, octylthio group, 2-ethylhexylthio group, nonylthio group, decylthio group, 3,7-dimethyloctylthio group, laurylthio group, trifluoromethylthio group and the like are mentioned, and preferable are a pentylthio group, hexylthio group, octylthio group, 2-ethylhexylthio group, decylthio group and 3,7-dimethyloctylthio group.

The aryl group has a carbon number of usually about from 6 to 60, preferably 7 to 48. Specifically, a phenyl group, C₁ to C₁₂ alkoxyphenyl groups (“C₁ to C₁₂ alkoxy” means that the alkoxy portions has a carbon number of about from 1 to 12, being applicable also in the following descriptions.), C₁ to C₁₂ alkylphenyl group (“C₁ to C₁₂ alkyl” means that the alkyl portion has a carbon number of about from 1 to 12, being applicable also in the following descriptions.), 1-naphthyl group, 2-naphthyl group, 1-anthracenyl group, 2-anthracenyl group, 9-anthracenyl group, pentafluorophenyl group and the like are illustrated, and preferable are C₁ to C₁₂ alkoxyphenyl groups and C₁ to C₁₂ alkylphenyl groups. Here, the aryl group is an atomic group obtained by removing one hydrogen atom from an aromatic hydrocarbon. Here, the aromatic hydrocarbon includes those having a condensed ring, and those having independent two or more benzene rings or condensed rings connected directly or via a group such as vinylene and the like. Further, the above-described aryl group optionally has a substituent, and the substituent includes C₁ to C₁₂ alkoxyphenyl groups, C₁ to C₁₂ alkylphenyl groups and the like.

As, Specific examples of the C₁ to C₁₂ alkoxy include methoxy, ethoxy, propyloxy, i-propyloxy, butoxy, i-butoxy, t-butoxy, pentyloxy, hexyloxy, cyclohexyloxy, heptyloxy, octyloxy, 2-ethylhexyloxy, nonyloxy, decyloxy, 3,7-dimethyloctyloxy, lauryloxy and the like.

Specific examples of the C₁ to C₁₂ alkylphenyl group include a methylphenyl group, ethylphenyl group, dimethylphenyl group, propylphenyl group, mesityl group, methylethylphenyl group, i-propylphenyl group, butylphenyl group, i-butylphenyl group, t-butylphenyl group, pentylphenyl group, isoamylphenyl group, hexylphenyl group, heptylphenyl group, octylphenyl group, nonylphenyl group, decylphenyl group, dodecylphenyl group and the like.

The aryloxy group has a carbon number of usually about from 6 to 60, preferably 7 to 48. Specifically, a phenoxy group, C₁ to C₁₂ alkoxyphenoxy groups, C₁ to C₁₂ alkylphenoxy groups, 1-naphthyloxy group, 2-naphthyloxy group, pentafluorophenyloxy group and the like are illustrated, and preferable are C₁ to C₁₂ alkoxyphenoxy groups and C₁ to C₁₂ alkylphenoxy groups.
Specific examples of the C₁ to C₁₂ alkoxy include methoxy, ethoxy, propyloxy, i-propyloxy, butoxy, i-butoxy, t-butoxy, pentyloxy, hexyloxy, cyclohexyloxy, heptyloxy, octyloxy, 2-ethylhexyloxy, nonyloxy, decyloxy, 3,7-dimethyloctyloxy, lauryloxy and the like.
Specific examples of the C₁ to C₁₂ alkylphenoxy group include a methylphenoxy group, ethylphenoxy group, dimethylphenoxy group, propylphenoxy group, 1,3,5-trimethylphenoxy group, methylethylphenoxy group, i-propylphenoxy group, butylphenoxy group, i-butylphenoxy group, t-butylphenoxy group, pentylphenoxy group, isoamylphenoxy group, hexylphenoxy group, heptylphenoxy group, octylphenoxy group, nonylphenoxy group, decylphenoxy group, dodecylphenoxy group and the like.

The arylthio group has a carbon number of usually about from 6 to 60, preferably 7 to 48. Specifically, a phenylthio group, C₁ to C₁₂ alkoxyphenylthio groups, C₁ to C₁₂ alkylphenylthio groups, 1-naphthylthio group, 2-naphthylthio group, pentafluorophenylthio group and the like are illustrated, and preferable are C₁ to C₁₂ alkoxyphenylthio groups and C₁ to C₁₂ alkylphenylthio groups.

The arylalkyl group has a carbon number of usually about from 7 to 60, preferably 7 to 48. Specifically, phenyl C₁ to C₁₂ alkyl groups, C₁ to C₁₂ alkoxyphenyl C₁ to C₁₂ alkyl groups, C₁ to C₁₂ alkylphenyl C₁ to C₁₂ alkyl groups, 1-naphthyl-C₁ to C₁₂ alkyl groups, 2-naphthyl C₁ to C₁₂ alkyl groups and the like are illustrated, and preferable are C₁ to C₁₂ alkoxyphenyl C₁ to C₁₂ alkyl groups and C₁ to C₁₂ alkylphenyl C₁ to C₁₂ alkyl groups.

The arylalkoxy group has a carbon number of usually about from 7 to 60, preferably 7 to 48. Specifically, phenyl C₁ to C₁₂ alkoxy groups such as a phenylmethoxy group, phenylethoxy group, phenylbutoxy group, phenylpentyloxy group, phenylhexyloxy group, phenylheptyloxy group, phenyloctyloxy group and the like, and C₁ to C₁₂ alkoxyphenyl C₁ to C₁₂ alkoxy groups, C₁ to C₁₂ alkylphenyl C₁ to C₁₂ alkoxy groups, 1-naphthyl C₁ to C₁₂ alkoxy groups, 2-naphthyl C₁ to C₁₂ alkoxy groups and the like are illustrated, and preferable are C₁ to C₁₂ alkoxyphenyl C₁ to C₁₂ alkoxy groups and C₁ to C₁₂ alkylphenyl C₁ to C₁₂ alkoxy groups.

The arylalkylthio group has a carbon number of usually about from 7 to 60, preferably 7 to 48. Specifically, phenyl C₁ to C₁₂ alkylthio groups, C₁ to C₁₂ alkoxyphenyl C₁ to C₁₂ alkylthio groups, C₁ to C₁₂ alkylphenyl C₁ to C₁₂ alkylthio groups, 1-naphthyl C₁ to C₁₂ alkylthio groups, 2-naphthyl C₁ to C₁₂ alkylthio groups and the like are illustrated, and preferable are C₁ to C₁₂ alkoxyphenyl C₁ to C₁₂ alkylthio groups and C₁ to C₁₂ alkylphenyl C₁ to C₁₂ alkylthio groups.

The acyl group has a carbon number of usually about from 2 to 20, preferably 2 to 18. Specifically, an acetyl group, propionyl group, butyryl group, isobutyryl group, pivaloyl group, benzoyl group, trifluoroacetyl group, pentafluorobenzoyl group and the like are illustrated.

The acyloxy group has a carbon number of usually about from 2 to 20, preferably 2 to 18. Specifically, an acetoxy group, propionyloxy group, butyryloxy group, isobutyryloxy group, pivaloyloxy group, benzoyloxy group, trifluoroacetyloxy group, pentafluorobenzoyloxy group and the like are illustrated.

The amide group has a carbon number of usually about from 2 to 20, preferably 2 to 18. Specifically, a formamide group, acetamide group, propioamide group, butyroamide group, benzamide group, trifluoroacetamide group, pentafluorobenzamide group, diformamide group, diacetamide group, dipropioamide group, dibutyroamide group, dibenzamide group, ditrifluoroacetamide group, dipentafluorobenzamide group and the like are illustrated.

The acid imide group means a monovalent residue obtained by removing from an acid imine one hydrogen atom connected to its nitrogen atom. This acid imide group usually has a carbon number of about from 2 to 60, preferably 2 to 48. Specific examples include groups of the following structural formulae, and the like.

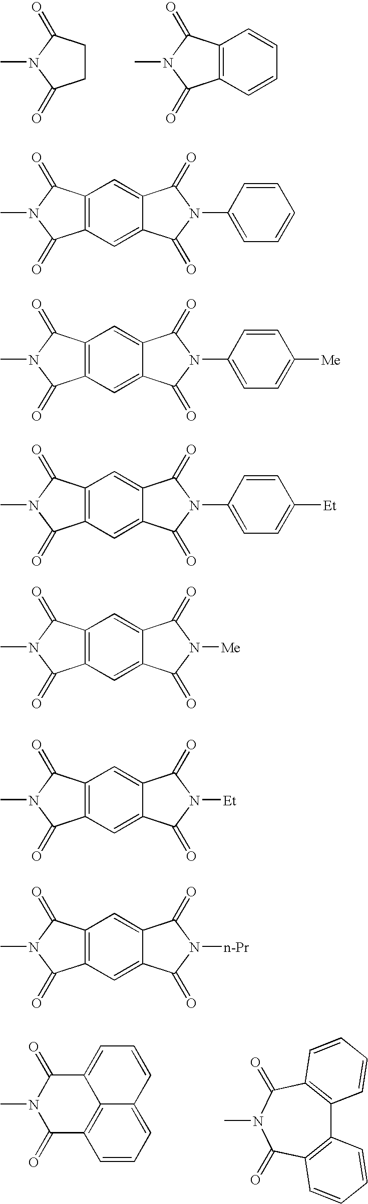

(wherein, — represents a connecting bond, Me represents a methyl group, Et represents an ethyl group, and n-Pr represents a n-propyl group, being applicable also in the following descriptions.).

The imine residue means a monovalent residue obtained by removing one hydrogen atom from an imine compound (that is, an organic compound having —N═C— in the molecule. Examples thereof include aldimine, ketimine, and compounds obtained by substitution of a hydrogen atom connected to a nitrogen atom in the molecule with an alkyl group and the like). This imine residue usually has a carbon number of about from 2 to 20, preferably 2 to 18. Specific examples include groups of the following structural formulae, and the like.

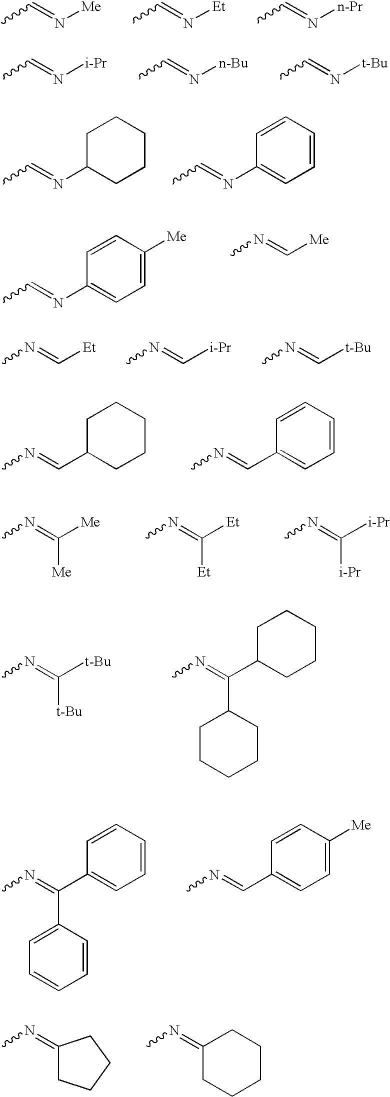

(wherein, i-Pr represents an i-propyl group, n-Bu represents a n-butyl group, t-Bu represents a t-butyl group. A bond shown by a wavy line means “bond represented by wedge” and/or “bond represented by broken line”. Here, “bond represented by wedge” means a bond protruding from the paper plane toward the hither side, and “bond represented by broken line” means a bond protruding toward the far side from the paper plane.

The substituted amino group is an amino group substituted with one or two groups selected from alkyl groups, aryl groups, arylalkyl groups or monovalent heterocyclic groups, and the alkyl group, aryl group, arylalkyl group or monovalent heterocyclic group optionally has a substituent. The carbon number thereof is usually about from 1 to 60, preferably 2 to 48 not including the carbon number of the substituent. Specific examples include a methylamino group, dimethylamino group, ethylamino group, diethylamino group, propylamino group, dipropylamino group, i-propylamino group, diisopropylamino group, butylamino group, i-butylamino group, t-butylamino group, pentylamino group, hexylamino group, cyclohexylamino group, heptylamino group, octylamino group, 2-ethylhexylamino group, nonylamino group, decylamino group, 3,7-dimethyloctylamino group, laurylamino group, cyclopentylamino group, dicyclopentylamino group, cyclohexylamino group, dicyclohexylamino group, pyrrolidyl group, piperidyl group, ditrifluoromethylamino group, phenylamino group, diphenylamino group, C₁ to C₁₂ alkoxyphenylamino groups, di(C₁ to C₁₂ alkoxyphenyl)amino groups, di(C₁ to C₁₂ alkylphenyl)amino groups, 1-naphthyl-amino group, 2-naphthylamino group, pentafluorophenylamino group, pyridylamino group, pyridazinylamino group, pyrimidylamino group, pyrazylamino group, triazylamino group, phenyl C₁ to C₁₂ alkylamino groups, C₁ to C₁₂ alkoxyphenyl C₁ to C₁₂ alkylamino groups, C₁ to C₁₂ alkylphenyl C₁ to C₁₂ alkylamino groups, di(C₁ to C₁₂ alkoxyphenyl C₁ to C₁₂ alkyl)amino groups, di(C₁ to C₁₂ alkylphenyl C₁ to C₁₂ alkyl)amino groups, 1-naphthyl-C₁ to C₁₂ alkylamino groups, 2-naphthyl C₁ to C₁₂ alkylamino groups and the like.

The substituted silyl group means a silyl group obtained by substitution with one, two or three groups selected from alkyl groups, aryl groups, arylalkyl groups or monovalent heterocyclic groups, and the carbon number thereof is usually about from 1 to 60, preferably 3 to 48. The alkyl group, aryl group, arylalkyl group or monovalent heterocyclic group optionally has a substituent.

Specific examples include a trimethylsilyl group, triethylsilyl group, tripropylsilyl group, tri-1-propylsilyl group, dimethyl-1-propylsilyl group, diethyl-1-propylsilyl group, t-butyldimethylsilyl group, pentyldimethylsilyl group, hexyldimethylsilyl group, heptyldimethylsilyl group, octyldimethylsilyl group, 2-ethylhexyl-dimethylsilyl group, nonyldimethylsilyl group, decyldimethylsilyl group, 3,7-dimethyloctyl-dimethylsilyl group, lauryldimethylsilyl group, phenyl C₁ to C₁₂ alkylsilyl groups, C₁ to C₁₂ alkoxyphenyl C₁ to C₁₂ alkylsilyl groups, C₁ to C₁₂ alkylphenyl C₁ to C₁₂ alkylsilyl groups, 1-naphthyl C₁ to C₁₂ alkylsilyl groups, 2-naphthyl C₁ to C₁₂ alkylsilyl groups, phenyl C₁ to C₁₂ alkyldimethylsilyl groups, triphenylsilyl group, tri-p-xylylsilyl group, tribenzylsilyl group, diphenylmethylsilyl group, t-butyldiphenylsilyl group, dimethylphenylsilyl group and the like.

The substituted silyloxy group means a silyloxy group substituted with one, two or three groups selected from alkoxy groups, aryloxy groups, arylalkoxy groups or monovalent heterocyclic oxy groups, and the carbon number thereof is usually about from 1 to 60, preferably 3 to 48. The alkoxy group, aryloxy group, arylalkoxy group or monovalent heterocyclic oxy group optionally has a substituent. Specifically, a trimethylsilyloxy group, triethylsilyloxy group, tripropylsilyloxy group, tri-1-propylsilyloxy group, dimethyl-1-propylsilyloxy group, diethyl-1-propylsilyloxy group, t-butyldimethylsilyloxy group, pentyldimethylsilyloxy group, hexyldimethylsilyloxy group, heptyldimethylsilyloxy group, octyldimethylsilyloxy group, 2-ethylhexyldimethylsilyloxy group, nonyldimethylsilyloxy group, decyldimethylsilyloxy group, 3,7-dimethyloctyldimethylsilyloxy group, lauryldimethylsilyloxy group, phenyl C₁ to C₁₂ alkylsilyloxy groups, C₁ to C₁₂ alkoxyphenyl C₁ to C₁₂ alkylsilyloxy groups, C₁ to C₁₂ alkylphenyl C₁ to C₁₂ alkylsilyloxy groups, 1-naphthyl-C₁ to C₁₂ alkylsilyloxy groups, 2-naphthyl C₁ to C₁₂ alkylsilyloxy groups, phenyl C₁ to C₁₂ alkyldimethylsilyloxy groups, triphenylsilyloxy group, tri-p-xylylsilyloxy group, tribenzylsilyloxy group, diphenylmethylsilyloxy group, t-butyldiphenylsilyloxy group, dimethylphenylsilyloxy group and the like are illustrated.

The substituted silylthio group means a silylthio group substituted with one, two or three groups selected from alkylthio groups, arylthio groups, arylalkylthio groups or monovalent heterocyclic thio groups, and the carbon number thereof is usually about from 1 to 60, preferably 3 to 48. The alkoxy group, arylthio group, arylalkylthio group or monovalent heterocyclicthio group optionally has a substituent. Specifically, a trimethylsilylthio group, triethylsilylthio group, tripropylsilylthio group, tri-1-propylsilylthio group, dimethyl-1-propylsilylthio group, diethyl-1-propylsilylthio group, t-butyldimethylsilylthio group, pentyldimethylsilylthio group, hexyldimethylsilylthio group, heptyldimethylsilylthio group, octyldimethylsilylthio group, 2-ethylhexyldimethylsilylthio group, nonyldimethylsilylthio group, decyldimethylsilylthio group, 3,7-dimethyloctyldimethylsilylthio group, lauryldimethylsilylthio group, phenyl C₁ to C₁₂ alkylsilylthio groups, C₁ to C₁₂ alkoxyphenyl C₁ to C₁₂ alkylsilylthio groups, C₁ to C₁₂ alkylphenyl C₁ to C₁₂ alkylsilylthio groups, 1-naphthyl-C₁ to C₁₂ alkylsilylthio groups, 2-naphthyl C₁ to C₁₂ alkylsilylthio groups, phenyl C₁ to C₁₂ alkyldimethylsilylthio groups, triphenylsilylthio group, tri-p-xylylsilylthio group, tribenzylsilylthio group, diphenylmethylsilylthio group, t-butyldiphenylsilylthio group, dimethylphenylsilylthio group and the like are illustrated.

The substituted silylamino group means a silylamino group substituted with one, two or three groups selected from alkylamino groups, arylamino groups, arylalkylamino groups or monovalent heterocyclic amino groups, and the carbon number thereof is usually about from 1 to 60, preferably 3 to 48. The alkoxy group, arylamino group, arylalkylamino group or monovalent heterocyclic amino group optionally has a substituent. Specifically, a trimethylsilylamino group, triethylsilylamino group, tripropylsilylamino group, tri-1-propylsilylamino group, dimethyl-1-propylsilylamino group, diethyl-1-propylsilylamino group, t-butyldimethylsilylamino group, pentyldimethylsilylamino group, hexyldimethylsilylamino group, heptyldimethylsilylamino group, octyldimethylsilylamino group, 2-ethylhexyldimethylsilylamino group, nonyldimethylsilylamino group, decyldimethylsilylamino group, 3,7-dimethyloctyldimethylsilylamino group, lauryldimethylsilylamino group, phenyl C₁ to C₁₂ alkylsilyloxy groups, C₁ to C₁₂ alkoxyphenyl C₁ to C₁₂ alkylsilylamino groups, C₁ to C₁₂ alkylphenyl C₁ to C₁₂ alkylsilylamino groups, 1-naphthyl-C₁ to C₁₂ alkylsilylamino groups, 2-naphthyl C₁ to C₁₂ alkylsilylamino groups, phenyl C₁ to C₁₂ alkyldimethylsilylamino groups, triphenylsilylamino group, tri-p-xylylsilylamino group, tribenzylsilylamino group, diphenylmethylsilylamino group, t-butyldiphenylsilylamino group, dimethylphenylsilylamino group and the like are illustrated.

The monovalent heterocyclic group means an atomic group remaining after removal of one hydrogen atom from a heterocyclic compound, and the carbon number thereof is usually about from 4 to 60, preferably 4 to 20. The carbon number of a heterocyclic group does not include the carbon number of a substituent. Here, the heterocyclic compound means an organic compound having a cyclic structure in which elements constituting the ring include not only a carbon atom but also hetero atoms such as oxygen, sulfur, nitrogen, phosphorus, boron and the like contained in the ring. Specifically, a thienyl group, C₁ to C₁₂ alkylthienyl groups, pyrrolyl group, furyl group, pyridyl group, C₁ to C₁₂ alkylpyridyl groups, piperidyl group, quinolyl group, isoquinolyl group and the like are illustrated, and preferable are a thienyl group, C₁ to C₁₂ alkylthienyl groups, pyridyl group and C₁ to C₁₂ alkylpyridyl groups.

The heteroaryloxy group has a carbon number of usually about from 6 to 60, preferably 7 to 48. Specifically, a thienyl group, C₁ to C₁₂ alkoxythienyl groups, C₁ to C₁₂ alkylthienyl groups, pyridyloxy group, pyridyloxy group, isoquinolyloxy group and the like are illustrated, and preferable are C₁ to C₁₂ alkoxypyridyl groups and C₁ to C₁₂ alkylpyridyl groups.
Specific examples of the C₁ to C₁₂ alkoxy include methoxy, ethoxy, propyloxy, i-propyloxy, butoxy, i-butoxy, t-butoxy, pentyloxy, hexyloxy, cyclohexyloxy, heptyloxy, octyloxy, 2-ethylhexyloxy, nonyloxy, decyloxy, 3,7-dimethyloctyloxy, lauryloxy and the like. Specific examples of the C₁ to C₁₂ alkylpyridyloxy group include a methylpyridyloxy group, ethylpyridyloxy group, dimethylpyridyloxy group, propylpyridyloxy group, 1,3,5-trimethylpyridyloxy group, methylethylpyridyloxy group, i-propylpyridyloxy group, butylpyridyloxy group, i-butylpyridyloxy group, t-butylpyridyloxy group, pentylpyridyloxy group, isoamylpyridyloxy group, hexylpyridyloxy group, heptylpyridyloxy group, octylpyridyloxy group, nonylpyridyloxy group, decylpyridyloxy group, dodecylpyridyloxy group and the like are illustrated.

The heteroarylthio group has a carbon number of usually about from 6 to 60, preferably 7 to 48. Specifically, a pyridylthio group, C₁ to C₁₂ alkoxypyridylthio groups, C₁ to C₁₂ alkylpyridylthio group, isoquinolylthio group and the like are illustrated, and preferable are C₁ to C₁₂ alkoxypyridylthio groups and C₁ to C₁₂ alkylpyridylthio groups

The arylalkenyl group has a carbon number of usually about from 7 to 60, preferably 7 to 48. Specifically, phenyl C₂ to C₁₂ alkenyl groups (“C₂ to C₁₂ alkenyl” means that the alkenyl portion has a carbon number of 2 to 12, being applicable also in the following descriptions.), C₁ to C₁₂ alkoxyphenyl C₂ to C₁₂ alkenyl groups, C₁ to C₁₂ alkylphenyl C₂ to C₁₂ alkenyl groups, 1-naphthyl C₂ to C₁₂ alkenyl groups, 2-naphthyl C₂ to C₁₂ alkenyl groups and the like are illustrated, and preferable are C₁ to C₁₂ alkoxyphenyl C₂ to C₁₂ alkenyl groups and C₂ to C₁₂ alkylphenyl C₁ to C₁₂ alkenyl groups.

The aryl alkynyl group has a carbon number of usually about from 7 to 60, preferably 7 to 48. Specifically, phenyl C₂ to C₁₂ alkynyl groups (“C₂ to C₁₂ alkynyl” means that the alkynyl portion has a carbon number of 2 to 12, being applicable also in the following descriptions.), C₁ to C₁₂ alkoxyphenyl C₂ to C₁₂ alkynyl groups, C₁ to C₁₂ alkylphenyl C₂ to C₁₂ alkynyl groups, 1-naphthyl C₂ to C₁₂ alkynyl groups, 2-naphthyl C₂ to C₁₂ alkynyl groups and the like are illustrated, and preferable are C₁ to C₁₂ alkoxyphenyl C₂ to C₁₂ alkynyl groups and C₁ to C₁₂ alkylphenyl C₂ to C₁₂ alkynyl groups.

The substituted carboxyl group usually has a carbon number of about from 2 to 60, preferably 2 to 48. It means a carboxyl group substituted with an alkyl group, aryl group, arylalkyl group or monovalent heterocyclic group, and a methoxycarbonyl group, ethoxycarbonyl group, propoxycarbonyl group, i-propoxycarbonyl group, butoxycarbonyl group, i-butoxycarbonyl group, t-butoxycarbonyl group, pentyloxycarbonyl group, hexyloxycarbonyl group, cyclohexyloxycarbonyl group, heptyloxycarbonyl group, octyloxycarbonyl group, 2-ethylhexyloxycarbonyl group, nonyloxycarbonyl group, decyloxycarbonyl group, 3,7-dimethyloctyloxycarbonyl group, dodecyloxycarbonyl group, trifluoromethoxycarbonyl group, pentafluoroethoxycarbonyl group, perfluorobutoxycarbonyl group, perfluorohexyloxycarbonyl group, perfluorooctyloxycarbonyl group, pyridyloxycarbonyl group, naphthoxycarbonyl group, pyridyloxycarbonyl group and the like are mentioned. The alkyl group, aryl group, arylalkyl group or monovalent heterocyclic group optionally has a substituent. The carbon number of the substituted carboxyl group does not include the carbon number of the substituent.

### —Second Metal Complex—

The second metal complex of the present invention has a structure of the above-described general formula (1), in which the above-described Z₁ ring has a structure of the above-described general formula (2) or the above-described Z₂ ring has a structure of the above-described general formula (3); alternatively, the above-described Z₁ ring has a structure of the above-described general formula (2) and the above-described Z₂ ring has a structure of the above-described general formula (3). In the second metal complex of the present invention, the metal atom M, X₁, X₂, Z₁ ring (including, namely, Z₁₀ ring, Z₁₁ ring, Y₁ and Y₂), Z₂ ring (including, namely, Z₂₀ ring, Z₂₁ ring, Y₃ and Y₄) and R^{A} to R^{F} are as explained and illustrated above.

Though the second metal complex of the present invention is not particularly restricted, those having a structure of the above-described general formula (4-1) or the above-described general formula (4-2) are preferable. The proportion (%) of the sum of squares of orbital coefficients of the outermost d orbital of the metal atom M, in the highest occupied molecular orbital of the metal complex, occupying with respect to the sum of squares of all atom orbital coefficients is preferably 33.3% or more, more preferably 33.3% or more and 66.7% or less, further preferably 40% or more and 66.7% or less, particularly preferably 50% or more and 66.7% or less.

Though the second metal complex of the present invention is not required to satisfy the above-described condition A (dihedral angle) and condition B (d orbital parameter), it is preferable to satisfy these conditions (in this case, included in the first metal complex described above) from the standpoints of the stability of a ligand and the light emission efficiency of a metal complex. As specific examples of the second metal complex of the present invention, the same examples as listed as specific examples of the first metal complex having a structure of the above-described general formula (1) (however, it is not necessary required to satisfy the above-described condition A and condition B) and the like are mentioned. Additionally, examples of the metal complex include

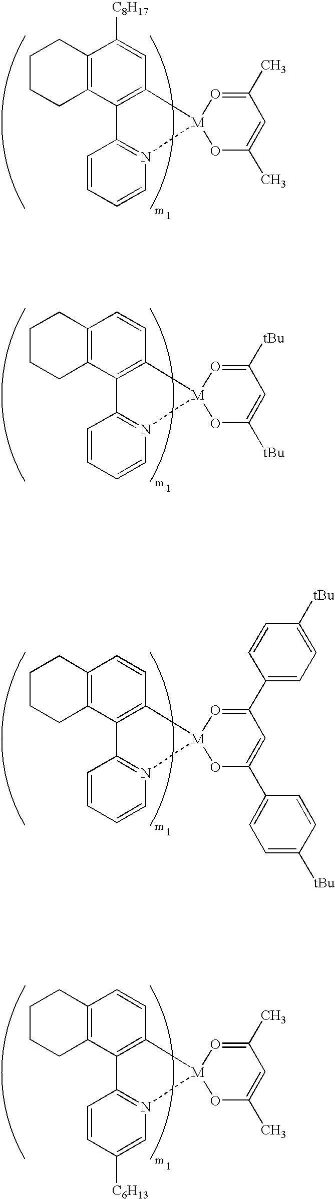

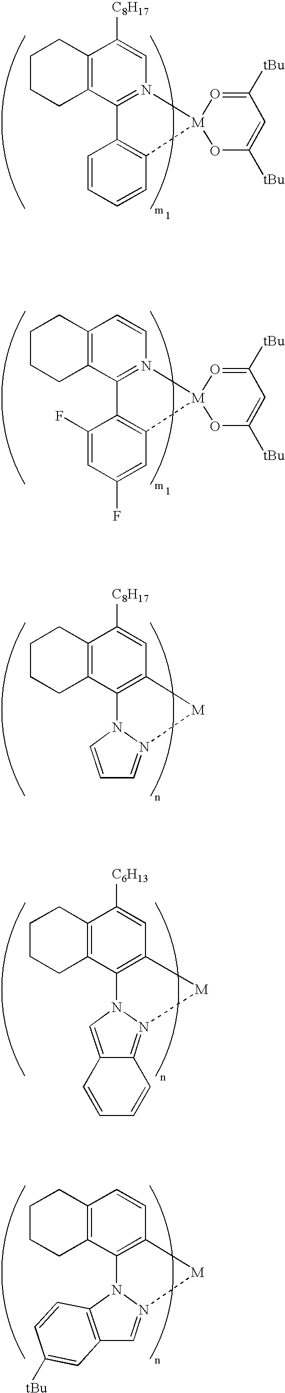

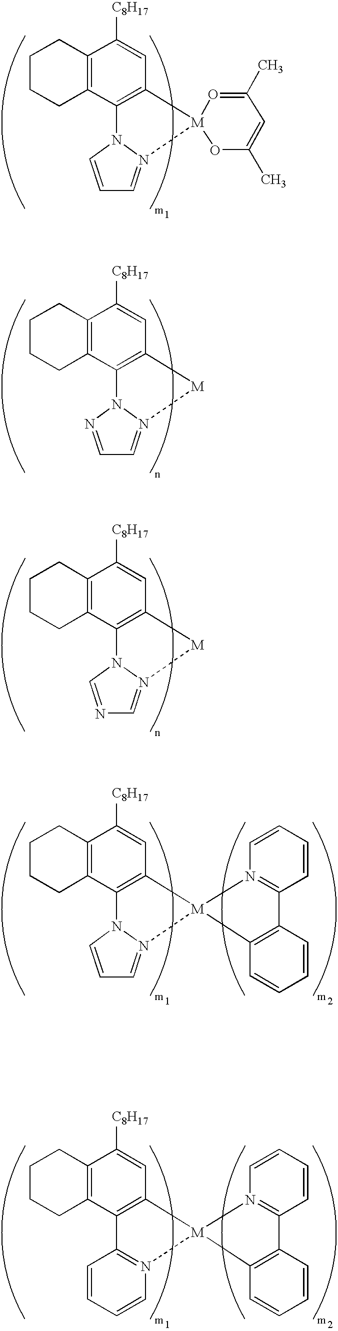

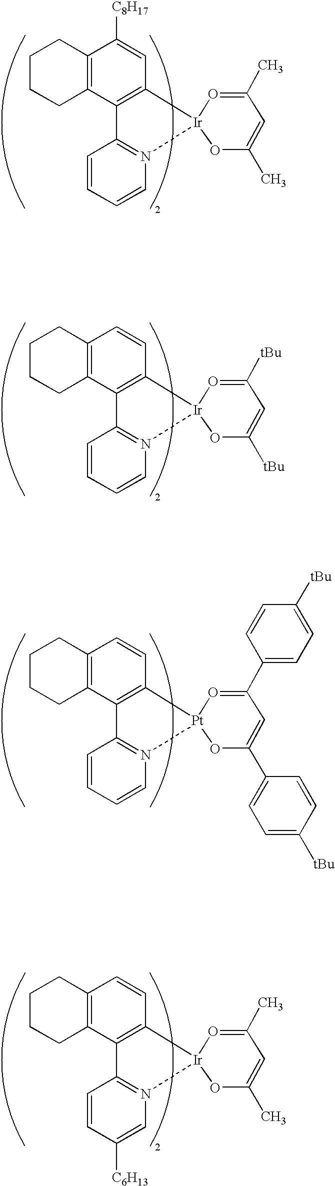

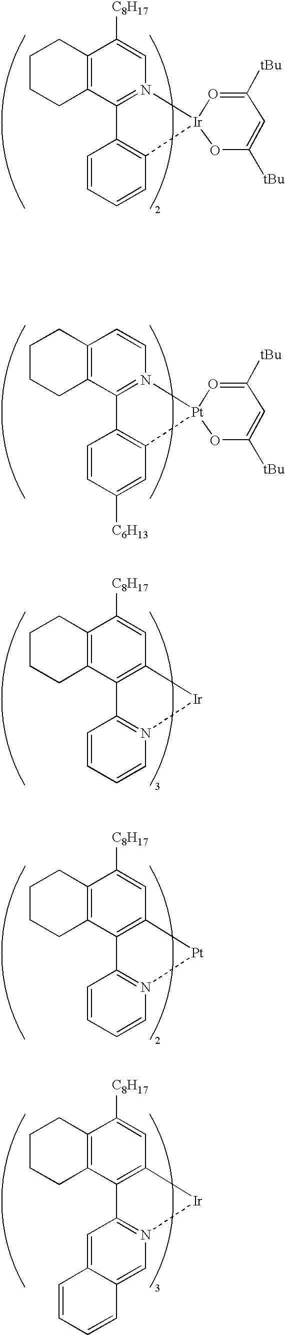

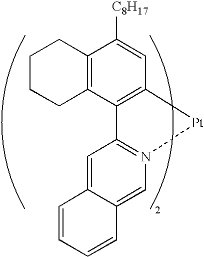

and the like.

The second metal complex of the present invention may be that represented by M(L)n (wherein, M, L and n represent the same meanings as described above.) constituted of the same ligand, or that represented by M(L)m₁(L₂)m₂, M(L)(L₂)(L₃) (wherein, M, L, L₂, L₃, m₁ and m₂ represent the same meanings as described above.) constituted of different ligands, and the like, like the first metal complex described above.

### —Third Metal Complex—

The third metal complex of the present invention has a structure of the above-described general formula (5). Though the third metal complex of the present invention is not required to satisfy the above-described condition A (dihedral angle) and condition B (d orbital parameter), it is preferable to satisfy these conditions from the standpoints of the stability of a ligand and the light emission efficiency of a metal complex. The preferable ranges and details of the condition A and the condition B are as described above.

In the third metal complex of the present invention, the metal atom M, X₁, X₂, Z₁ ring (including, namely, Z₁₀ ring, Z₁₁ ring, Y₁ and Y₂), Z₂ ring (including, namely, Z₂₀ ring, Z₂₁ ring, Y₃ and Y₄) and R^{A} to R^{D} are as explained and illustrated above.

In the above-described general formula (5), A represents a connecting group connected to one atom in the Z₁ ring and to one atom in the Z₂ ring, and the connecting group contains 2 to 6 groups selected from groups represented by —C(R⁵⁰¹)(R⁵⁰²)—, —N(R⁵⁰³)—, —P(R⁵⁰⁴)—, —P(═O)(R⁵⁰⁷)—, —Si(R⁵⁰⁵)(R⁵⁰⁶)— and SO₂—

The number of the above-described groups constituting the connecting group is usually 2 to 6, preferably 2 to 4, more preferably 2. As the connecting group, groups of the following formulae (5-A1) to (5-A10) are specifically illustrated.

—C(R⁵⁰¹)(R⁵⁰²)—N(R⁵⁰³)— (5-A1)

—C(R⁵⁰¹)(R⁵⁰²)—P(R⁵⁰⁴)— (5-A2)

—C(R⁵⁰¹)(R⁵⁰²)—Si(R⁵⁰⁵)(R⁵⁰⁶)— (5-A3)

—C(R⁵⁰¹)(R⁵⁰²)—P(═O)(R⁵⁰⁷)— (5-A4)

C(R⁵⁰¹)(R⁵⁰²)—SO₂— (5-A5)

—Si(R⁵⁰⁵)(R⁵⁰⁶)—N(R⁵⁰³)— (5-A6)

—Si(R⁵⁰⁵)(R⁵⁰⁶)—P(R⁵⁰⁴) (5-A7)

—Si(R⁵⁰⁵)(R⁵⁰⁶)—Si(R⁵⁰⁵)(R⁵⁰⁶) (5-A8)

—Si(R⁵⁰⁵)(R⁵⁰⁶)—P(═O)(R⁵⁰⁷) (5-A9)

—Si(R⁵⁰⁵)(R⁵⁰⁶)—SO₂— (5-A10)

All or part of hydrogen atoms in the connecting group may be substituted by a fluorine atom. In the formulae, R⁵⁰¹ to R⁵⁰⁷ are as described above.

The alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, silyloxy group, substituted silyloxy group, monovalent heterocyclic group and halogen atom represented by the above-described R⁵⁰¹ to R⁵⁰⁷ are the same as those explained and illustrated above as the substituent which can be carried on the cyclic structure (for example, Z₁ ring, Z₂ ring and the like) to be contained in a ligand constituting a metal complex of the present invention.

Examples of the structure of the above-described general formula (5) include structures of the following general formulae:

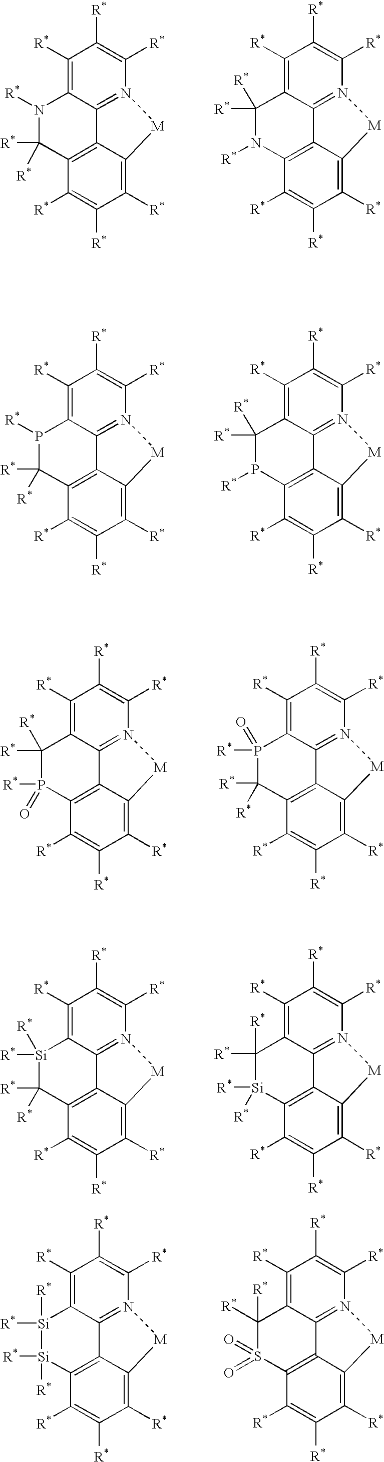

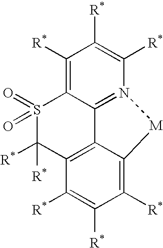

(wherein, M is as described above, and R*s represent each independently a hydrogen atom, alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, silyloxy group, substituted silyloxy group, monovalent heterocyclic group or halogen atom.) and the like.

Specific examples of the third metal complex of the present invention having a structure of the above-described general formula (5) include those having a structure of the following general formulae:

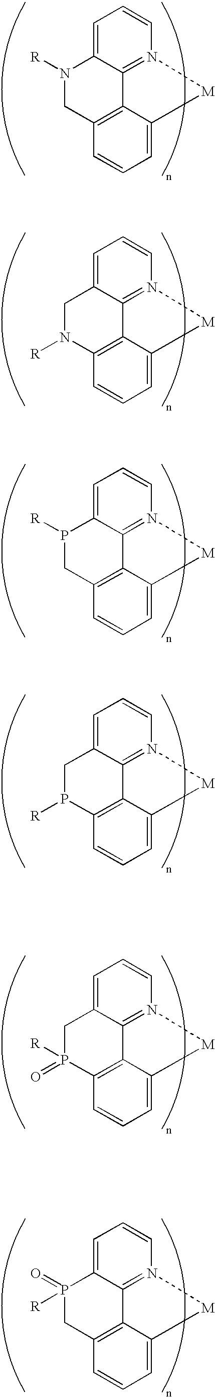

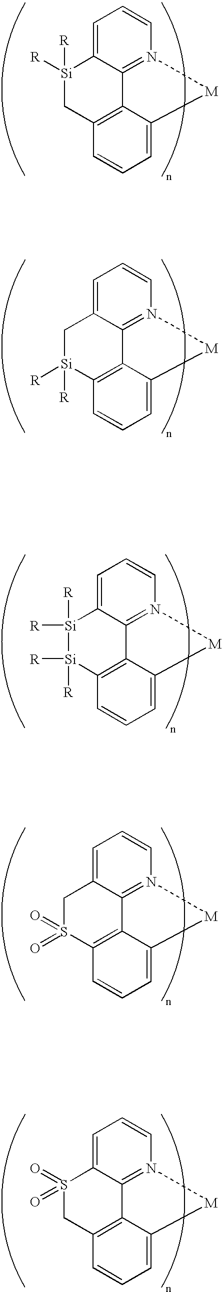

(wherein, M, n and R represent the same meanings as described above.) and the like.

The alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, silyloxy group, substituted silyloxy group, monovalent heterocyclic group and halogen atom represented by the above-described R are the same as those explained and illustrated above as the substituent which can be carried on the cyclic structure (for example, Z₁ ring, Z₂ ring and the like) to be contained in a ligand constituting a metal complex of the present invention.

The third metal complex of the present invention may be that represented by M(L)n (wherein, M, L and n represent the same meanings as described above.) constituted of the same ligand, or that represented by M(L)m₁(L₂)m₂, M(L)(L₂)(L₃) (wherein, M, L, L₂, L₃, m₁ and m₂ represent the same meanings as described above.) constituted of different ligands, and the like, like the first metal complex described above.

### —Method of Producing Complex—

Next, a method of synthesizing a metal complex of the present invention will be explained.

The metal complex of the present invention can be produced, for example, by the following method. That is, a compound having a part containing Z₁ ring and a compound having a part containing Z₂ ring are reacted by, for example, Suzuki coupling, Grignard coupling using a nickel catalyst, Stille coupling and the like to synthesize a compound as a ligand, and this is reacted with a salt of desired metal in a solution to make a complex, thus, the metal complex of the present invention can be synthesized.

The above-described synthesis of a compound as a ligand can be carried out, specifically, as described below: that is, a compound having a part containing Z₁ ring and a compound having a part containing Z₂ ring are, if necessary dissolved in an organic solvent, and reacted at a temperature of the melting point or higher and the boiling point or lower of the organic solvent, using, for example, an alkali, suitable catalyst and the like. For example, methods described in “Organic Reactions”, vol. 14, p. 270-490, John Wiley & Sons, Inc., 1965; “Organic Syntheses”, Collective Volume VI, p. 407-411, John Wiley & Sons, Inc., 1988; Chem. Rev., vol. 95, p 2457 (1995); J. Organomet. Chem., vol. 576, p. 147 (1999); J. Prakt. Chem., vol. 336, p. 247 (1994); Makromol. Chem., Macromol. Symp., vol. 12, p. 229 (1987) and the like can be used.

The organic solvent used for the above-described synthesis of a compound as a ligand varies with compounds and reactions to be used, and in general for suppressing side reactions, those subjected to a sufficient deoxidation treatment are used. It is preferable to progress the reaction in an inert atmosphere. Further, it is preferable that the above-described organic solvent is previously subjected to a dehydration treatment. However, this is not the case when a reaction in a two-phase system with water is conducted such as in the Suzuki coupling reaction.

For progressing the reaction in the above-described synthesis of a compound as a ligand, an alkali, suitable catalyst and the like are appropriately added. These alkali and suitable catalyst may be selected depending on the reaction to be used, and those dissolved sufficiently in a solvent to be used in the reaction are preferable. As a method of mixing an alkali and suitable catalyst with a substrate, there are illustrated a method in which an alkali and suitable catalyst are added slowly while stirring the reaction liquid (that is, liquid prepared by dissolving or dispersing a substrate in an organic solvent) under an inert atmosphere such as argon, nitrogen and the like, and a method in which, reversely, the reaction liquid is added slowly to an alkali and suitable catalyst.

In the above-described synthesis of a compound as a ligand, the reaction temperature is not particularly restricted, and usually about from −100 to 350° C., preferably 0° C. to the boiling point of a solvent. The reaction time is not particularly restricted, and usually about from 30 minutes to 30 hours.

In the above-described synthesis of a compound as a ligand, a method of removal of an intended material (compound as a ligand) from the reaction mixture and purification thereof after completion of the above-described reaction varies depending on the resultant compound as a ligand, and usual methods for purifying organic compounds such as, for example, re-crystallization, sublimation, chromatography and the like are used.

As a method of making a complex (that is, a method of reacting a compound as a ligand with a metal salt in a solution), for example, in the case of an iridium complex, methods described in Inorg. Chem. 1991, 30, 1685; Inorg. Chem. 2001, 40, 1704; Chem. Lett., 2003, 32, 252 and the like are illustrated, in the case of a platinum complex, methods described in Inorg. Chem., 1984, 23, 4249; Chem. Mater. 1999, 11, 3709; Organometallics, 1999, 18, 1801 and the like are illustrated, and in the case of a palladium complex, methods described in J. Org. Chem., 1987, 52, 73 and the like are illustrated.

Though the reaction temperature for making a complex is not particularly restricted, the reaction can be carried out usually from the melting point to the boiling point of a solvent, preferably from −78° C. to the boiling point of a solvent. The reaction time is not particularly restricted, and usually about from 30 minutes to 30 hours. When a microwave reaction apparatus is used in the method for making a complex, the reaction can be carried out also at the boiling point of a solvent or higher, and the reaction time is not particularly restricted, and from about from several minutes to several hours.

In the synthesis operation in the reaction of making a complex, a solvent is placed in a flask, deaeration is performed by bubbling with an inert gas such as a nitrogen gas, argon gas and the like while stirring the solvent, then, a metal salt and a compound as a ligand are added. The temperature is raised to a temperature of ligand exchange under an inert gas atmosphere while stirring thus obtained solution, and stirring is continued while thermally insulating. The end point of the reaction can be determined by stopping of decrease in raw materials or disappearance of any raw material by TLC monomer or high performance liquid chromatography.

A method of removal of an intended material (metal complex) from the reaction mixture obtained by the above-described reaction and purification thereof varies with the metal complex, and usual methods for purifying complexes such as, for example, re-crystallization, sublimation, chromatography and the like are used. Specifically, for example, 1 N hydrochloric acid aqueous solution as a poor solvent is added to the reaction mixture to cause deposition of a metal complex, this is removed by filtration, and this solid is dissolved in an organic solvent such as dichloromethane, chloroform and the like. This solution is filtrated to remove insoluble materials, concentrated again, purified by silica gel column chromatography (elution with dichloromethane), fraction solutions of an intended material are collected, and for example, methanol (poor solvent) is added in a suitable amount, the solution is concentrated to cause deposition of a metal complex as an intended material, and this is filtrated and dried, to obtain a metal complex.

Identification and analysis of a compound can be carried out by CHN element analysis, NMR analysis and MS analysis.

For example, a complex of the present invention of the following formula (A):

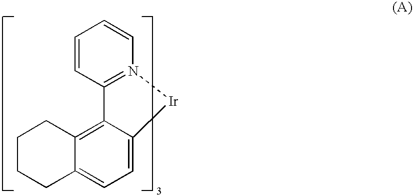

can be synthesized by a synthesis route shown below.

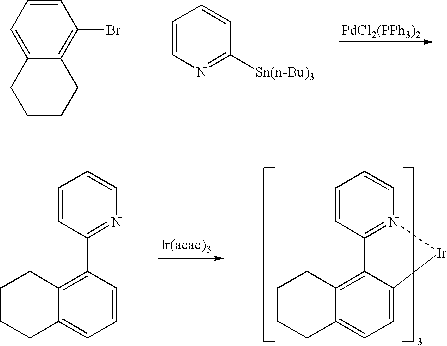

### <Polymer Compound>

A residue of a metal complex of the present invention can be incorporated in a molecule to obtain a polymer compound. As the above-described molecule into which a residue of a metal complex is incorporated, for example, polymer organic compounds to be used as a charge transporting material described later are mentioned, and conjugated polymer organic compounds are preferable since conjugation spreads to enhance carrier (electron or hole) mobility.

When a metal complex of the present invention is incorporated into a polymer organic compound, examples of polymer compounds having a structure of a polymer organic compound and a residue of a metal complex in the same molecule include

1. polymer compounds having a residue of a metal complex on the main chain of a polymer organic compound;

2. polymer compounds having a residue of a metal complex on the end of a polymer organic compound;

3. polymer compounds having a residue of a metal complex on the side chain of a polymer organic compound; and the like. When the main chain carries a residue of a metal complex, also those in which three or more polymer chains are connected to a metal complex are included, in addition to those in which a metal complex is incorporated into the main chain of a linear polymer.

Examples of the above-described polymer compound include those containing a residue of a metal complex having a structure of the above-described general formula (1), the above-described general formula (5) or the like, having a polystyrene-reduced number average molecular weight of 10³ to 10⁸, and having a residue of a metal complex having a structure of the above-described general formula (1), the above-described general formula (5) or the like on its side chain, main chain or end or on two or more of them. In the present specification, “residue of a metal complex” is a k-valent group obtained by removing k hydrogen atoms from the above-described metal complex. Here, k is an integer of 1 to 6.

The polymer compound having a residue of a metal complex on the main chain of a polymer organic compound is represented, for example, by the following formula:

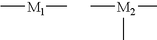

(wherein, M₁, M₂ represent a residue of a metal complex, and its connecting bond is held by a ligand of the metal complex. The M₁, M₂ are connected via the connecting bond to a repeating unit forming a polymer chain. A solid line represents a polymer organic compound to which a residue of a metal complex is connected.).

The polymer compound having a residue of a metal complex on the end of a polymer organic compound is represented, for example, by the following formula:

—X - - - M₃

(wherein, M₃ represents a monovalent residue of a metal complex, and its connecting bond is held by a ligand of the metal complex. The M₃ is connected via the connecting bond to X. X represents a single bond, optionally substituted alkenylene group, optionally substituted alkynylene group, optionally substituted arylene group, or optionally substituted divalent heterocyclic group. A portion constituted of a solid line and X represents a polymer organic compound to which a residue of a metal complex is connected. A broken line represents a single bond.).

The polymer compound having a residue of a metal complex on the side chain of a polymer organic compound is represented, for example, by the following formula:

—Ar—

(wherein, Ar represents a divalent aromatic group, or a divalent heterocyclic group having at least one atom selected from the group consisting of an oxygen atom, silicon atom, germanium atom, tin atom, phosphorus atom, boron atom, sulfur atom, selenium atom and tellurium atom, the above-described Ar has 1 to 4 groups represented by -L- M₄, M₄ represents a monovalent residue of a metal complex, L represents a single bond, —O—, —S—, —CO—, —CO₂—, —SO—, —SO₂—, —SiR⁶⁸R⁶⁹—, NR⁷⁰—, —BR⁷¹—, —PR⁷²—, —P(═O)(R⁷³)—, optionally substituted alkylene group, optionally substituted alkenylene group, optionally substituted alkynylene group, optionally substituted arylene group, or optionally substituted divalent heterocyclic group, and when the alkylene group, the alkenylene group and the alkynylene group contain a —CH₂— group, at least one —CH₂— group contained in the alkylene group, at least one —CH₂— group contained in the alkenylene group and at least one —CH₂— group contained in the alkynylene group may be each substituted with a group selected from the group consisting of —O—, —S—, —CO—, —CO₂—, —SO—, —SO₂—, —SiR⁷⁴R⁷⁵—, NR⁷⁶—, —BR⁷⁷—, —PR⁷⁸— and —P(═O)(R⁷⁹)—. R⁶⁸ to R⁷⁹ represent each independently a group selected from the group consisting of a hydrogen atom, alkyl group, aryl group, monovalent heterocyclic group and cyano group. Ar may further have a substituent selected from the group consisting of an alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group and cyano group, in addition to the group represented by -L-M₄. When Ar has two or more of substituents, they may be the same or different. A solid line represents a polymer organic compound to which Ar having a residue of a metal complex is connected.).

In the above-described formulae, the alkyl group, aryl group, monovalent heterocyclic group and cyano group represented by R⁶⁸ to R⁷⁹, and the alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group and cyano group as the substituent optionally carried on Ar, are the same as those explained and illustrated as the substituent which can be carried on the cyclic structure (for example, Z₁ ring, Z₂ ring and the like) contained in a ligand constituting a metal complex of the present invention described above.

In the above-described formulae, examples of the divalent aromatic group include phenylene, pyridinylene, pyrimidilene, naphthylene, or a ring of the following general formula (6), and the like.

In the above-described formulae, the divalent heterocyclic group means an atomic group remaining after removal of two hydrogen atoms from a heterocyclic compound, and the carbon number thereof is usually about from 4 to 60, preferably 4 to 20. The carbon number of the heterocyclic group does not include the carbon number of a substituent. The heterocyclic compound is the same as explained and illustrated for the above-described monovalent heterocyclic group.

Though the above-described polymer compound is not particularly restricted providing it has in its molecule a residue of a first metal complex, a residue of a second metal complex or a residue of a third metal complex described above, or a combination of two or more of them, preferable are those not significantly deteriorating charge transportability, charge injectability and the like, and specifically, conjugated polymers excellent in carrier (electron or hole) transportability are preferable. It is preferable that the conjugated polymer contains a divalent aromatic group optionally having a substituent. This divalent aromatic group is preferably, for example, a divalent heterocyclic group optionally having a substituent, a divalent aromatic amine group optionally having a substituent, or a group of the following general formula (6):

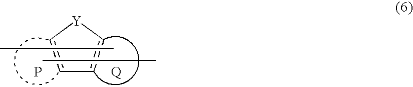

(wherein, P ring and Q ring represent each independently an aromatic ring, however, P ring may not be present. Two connecting bonds are present on P ring and/or Q ring when P ring is present, and on a 5-membered ring or 6-membered ring containing Y and/or Q ring when P ring is not present. P ring, Q ring and 5-membered ring or 6-membered ring containing Y may each independently have at least one substituent selected from the group consisting of an alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group and cyano group. Y represents —O—, —S—, —Se—, —B(R⁶)—, —Si(R⁷)(R⁸)—, —P(R⁹)—, —PR¹⁰(═O)—, —C(R¹¹)(R¹²)—, —N(R¹³)—, —C(R¹⁴)(R¹⁵)—C(R¹⁶) (R¹⁷)—, —O—C(R¹⁸)(R¹⁹)—, —S—C(R²⁰)(R²¹)—, —N—C(R²²)(R²³)—, —Si(R²⁴)(R²⁵)—C(R²⁶)(R²⁷)—, —Si(R²⁸)(R²⁹)—Si(R³⁰)(R³¹)—, —C(R³²)═C(R³³)—, —N═C(R³⁴)— or Si(R³⁵)═C(R³⁶)—. R⁶ to R³⁶ represent each independently a hydrogen atom, alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, silyloxy group, substituted silyloxy group, monovalent heterocyclic group or halogen atom.). One or two or more of these groups may be present in a polymer compound (polymer organic compound in the case described later), however, these groups may also be present as repeating units.

The above-described divalent aromatic group is an atomic group obtained by removing two hydrogen atoms from an aromatic compound, and includes those having a condensed ring, and those having independent two or more benzene rings or condensed rings connected directly or via a group such as vinylene and the like. The aromatic group optionally has a substituent.

The above-described divalent heterocyclic group means an atomic group remaining after removal of two hydrogen atoms from a heterocyclic compound, and the group optionally has a substituent. The heterocyclic compound means an organic compound having a cyclic structure in which elements constituting the ring include not only a carbon atom but also at least one atom selected from the group consisting of an oxygen atom, nitrogen atom, silicon atom, germanium atom, tin atom, phosphorus atom, boron atom, sulfur atom, selenium atom and tellurium atom. Among divalent heterocyclic groups, aromatic heterocyclic groups are preferable. A portion of the divalent heterocyclic group excepting substituents has a carbon number of usually about from 3 to 60. The total carbon number of the divalent heterocyclic group including substituents is usually about from 3 to 100.

The divalent aromatic amine group means an atomic group remaining after removal of two hydrogen atoms from an aromatic amine. The divalent aromatic amine group has a carbon number of usually about from 5 to 100, preferably 15 to 60. The carbon number of the divalent aromatic amine group does not include the carbon number of substituents.

As the divalent aromatic amine group, groups of the following general formula (7) illustrated.

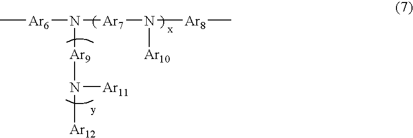

(wherein, Ar₆, Ar₇, Ar₈ and Ar₉ represent each independently an arylene group or divalent heterocyclic group. Ar₁₀, Ar₁₁ and Ar₁₂ represent each independently an aryl group or monovalent heterocyclic group. Ar₆ to Ar₁₂ optionally have a substituent. x and y represent each independently 0 or 1, and 0=x+y=1.).

In the above-described general formula (7), the arylene group represented by Ar₆ to Ar₉ is an atomic group obtained by removing two hydrogen atoms from an aromatic hydrocarbon, and includes those having a condensed ring, and those having independent two or more benzene rings or condensed rings connected directly or via a group such as vinylene and the like. The arylene group optionally has a substituent. A portion of the arylene group excepting substituents has a carbon number of usually about from 6 to 60, preferably 6 to 20. The total carbon number of the arylene group including substituents is usually about from 6 to 100.

In the above-described general formula (7), the divalent heterocyclic group represented by Ar₆ to Ar₉ is the same as explained and illustrated as the divalent heterocyclic group in the section of the above-described divalent aromatic group.

In the above-described general formula (7), the aryl group and monovalent heterocyclic group represented by Ar₁₀ to Ar₁₂ are the same as explained and illustrated as the substituent which can be carried on the cyclic structure (for example, Z₁ ring, Z₂ ring and the like) contained in a ligand constituting a metal complex of the present invention.

The substituent optionally carried on the above-described divalent aromatic group, the above-described divalent heterocyclic group, the above-described divalent aromatic amine group, and the arylene group, divalent heterocyclic group, aryl group and monovalent heterocyclic group in the above-described general formula (7), include an alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group, cyano group and nitro group. These substituents are, specifically, the same as explained and illustrated as the substituent which can be carried on the cyclic structure (for example, Z₁ ring, Z₂ ring and the like) contained in a ligand constituting a metal complex of the present invention.

In the above-described general formula (6), the alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, silyloxy group, substituted silyloxy group, monovalent heterocyclic group and halogen atom represented by R⁶ to R³⁶ are the same as explained and illustrated as the substituent which can be carried on the cyclic structure (for example, Z₁ ring, Z₂ ring and the like) contained in a ligand constituting a metal complex of the present invention.

The group of the above-described formula (6) includes groups of the following general formula (6-1), the following general formula (6-2) or the following general formula (6-3):

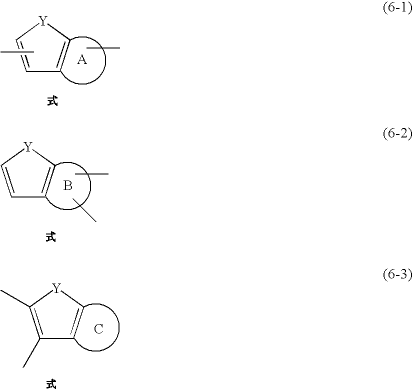

(wherein, A ring, B ring and C ring represent each independently an aromatic ring. The formula (6-1), formula (6-2) and formula (6-3) may each have at least one substituent selected from the group consisting of an alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group and cyano group. Y represents the same meaning as described above.); and groups of the following general formula (6-4) or the following general formula (6-5):

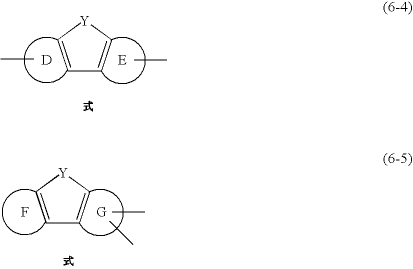

(wherein, D ring, E ring, F ring and G ring represent each independently an aromatic ring optionally having at least one substituent selected from the group consisting of an alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group and cyano group. Y represents the same meaning as described above.), and preferable are groups of the above-described general formula (6-4) or the above-described general formula (6-5).

In the above-described formulae, Y represents preferably —S—, —O— or —C(R¹¹)(R¹²)— from the standpoint of obtaining high light emission efficiency, and further preferably —S— or —O—. Here, R¹¹, R¹² represent the same meanings as described above.

The aromatic ring in the above-described general formulae (6-1) to (6-5) includes aromatic hydrocarbon rings such as a benzene ring, naphthalene ring, anthracene ring, tetracene ring, pentacene ring, pyrene ring, phenanthrene ring and the like; and heteroaromatic rings such as a pyridine ring, bipyridine ring, phenanthroline ring, quinoline ring, isoquinoline ring, thiophene ring, furan ring, pyrrole ring and the like.

Groups of the above-described general formulae (6-1) to (6-5) preferably have a group selected from an alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, acyloxy group, imine residue, amide group, acid imide group, monovalent heterocyclic group, carboxyl group or substituted carboxyl group, as the substituent.

### <Composition>

The above-described metal complex and/or polymer compound can be used to prepare a composition by combining with a charge transporting material and/or a light emitting material. That is, the composition of the present invention comprises the above-described metal complex and/or polymer compound, and a charge transporting material and/or a light emitting material.

The above-described charge transporting materials are classified into hole transporting materials and electron transporting materials, and specifically, organic compounds (low molecular weight organic compounds and/or polymer organic compounds) can be used.

Examples of the hole transporting material include carbazole or derivatives thereof, polysilane or derivatives thereof, polysiloxane derivatives having an aromatic amine on the side chain or main chain, pyrazoline derivatives, arylamine derivatives including triphenyldiamine derivatives and the like, stilbene derivatives, polyaniline or derivatives thereof, polythiophene or derivatives thereof, polypyrrole or derivatives thereof, poly(p-phenylenevinylene) or derivatives thereof, or poly(2,5-thienylenevinylene) or derivatives thereof, poly(p-phenylene) or derivatives thereof and the like.

The electron transporting material includes oxadiazole derivatives, anthraquinodimethane or derivatives thereof, benzoquinone or derivatives thereof, naphthoquinone or derivatives thereof, anthraquinone or derivatives thereof, tetracyanoanthraquinodimethane or derivatives thereof, fluorenone derivatives, diphenyldicyanoethylene or derivatives thereof, diphenoquinone derivatives, or metal complexes of 8-hydroxyquinoline or derivatives thereof, polyquinoline or derivatives thereof, polyquinoxaline or derivatives thereof, polyfluorene or derivatives thereof.

The low molecular weight organic compound to be used as the charge transporting material means a host compound used in a low molecular weight organic EL device (namely, low molecular weight host compound), a charge injection and transporting compound or the like, and specifically, for example, compounds described in “Organic EL Display” (Shizuo Tokito, Chihaya Adachi, Hideyuki Murata joint work, Ohmsha, Ltd.) p. 107, Monthly Display, vol. 9, No. 9, 2003, p. 26-30, Japanese Patent Application Laid-Open (JP-A) No. 2004-244400, JP-A No. 2004-277377, and the like are listed.

The low molecular weight organic compound includes, specifically, the following compounds.

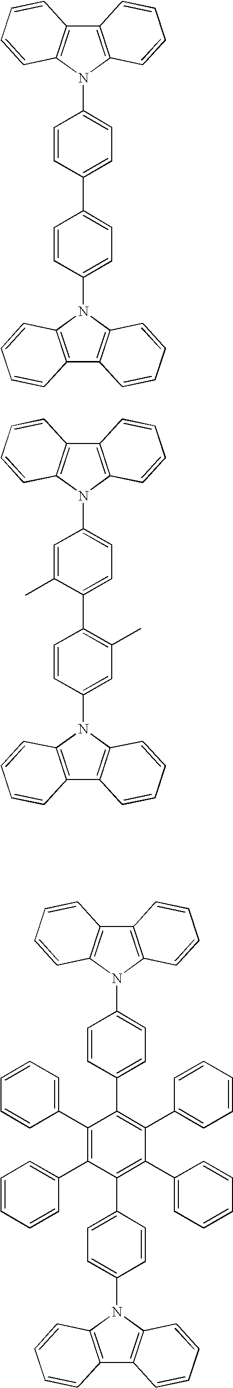

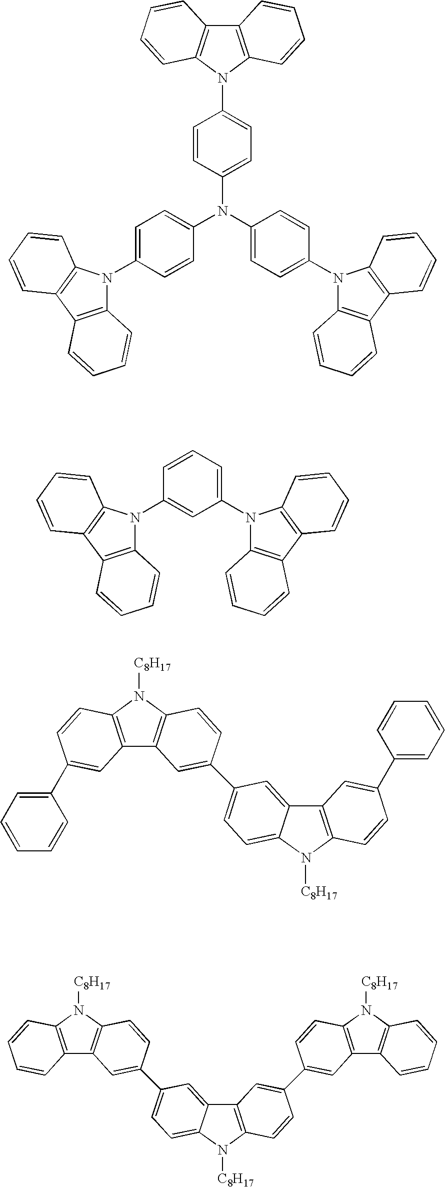

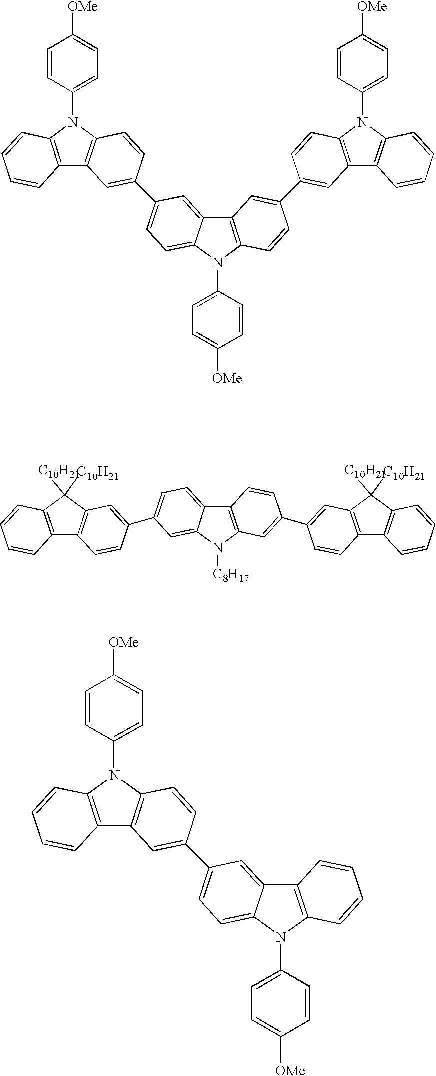

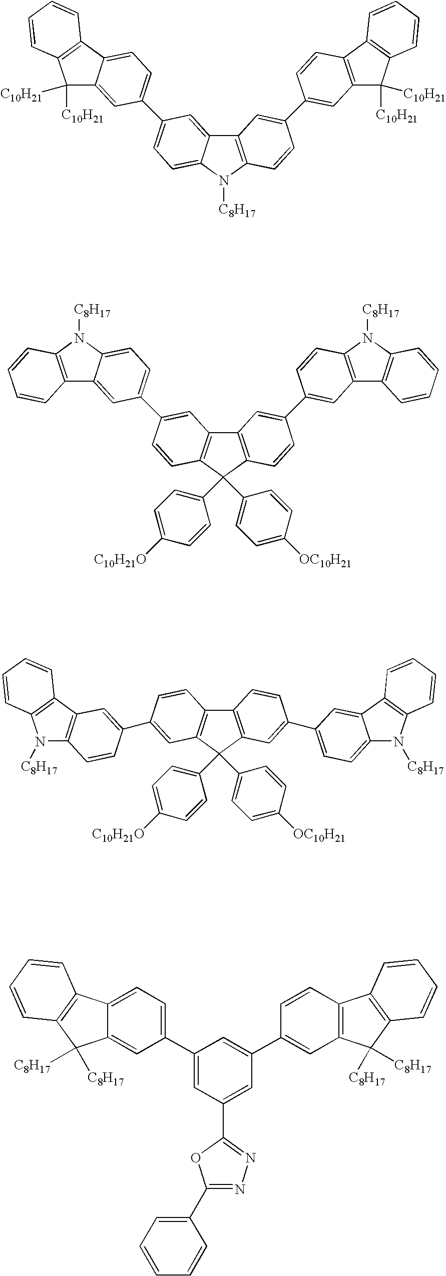

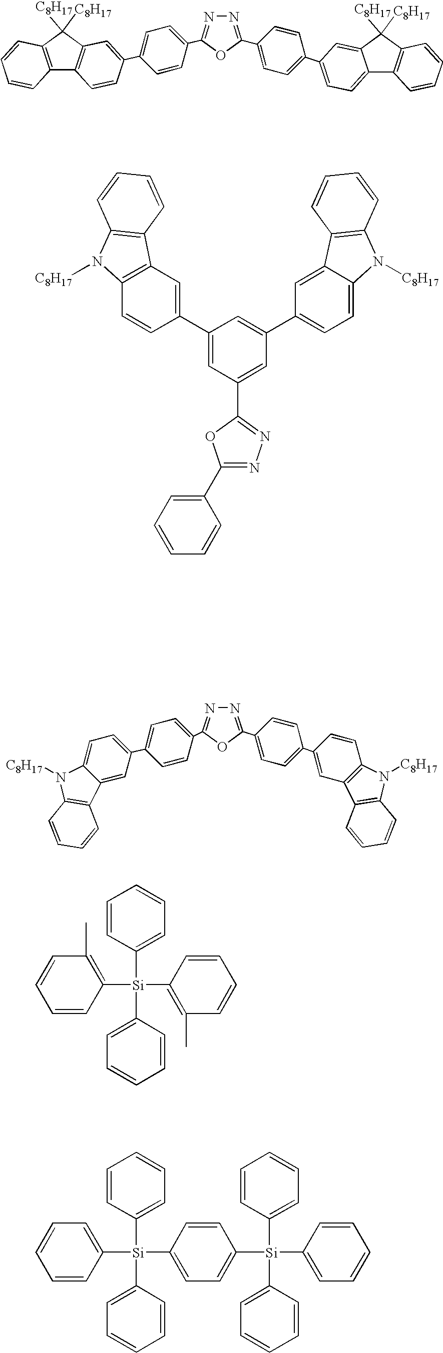

Examples of the polymer organic compound to be used as the charge transporting material include non-conjugated polymer organic compounds and conjugated polymer organic compounds, and preferable from the standpoint of charge transportation are conjugated polymer organic compounds since conjugation spreads and carrier (electron or hole) mobility is high advantageously. Examples of the non-conjugated polymer organic compound include polyvinylcarbazole and the like. Examples of the conjugated polymer organic compound include polymers containing an aromatic ring in the main chain, and specifically, for example, those containing a phenylene group optionally having a substituent, fluorene optionally having a substituent, dibenzothiophene optionally having a substituent, dibenzofuran optionally having a substituent, dibenzosilole optionally having a substituent, and the like, as a repeating unit in the main chain, and copolymers with the repeating unit, and the like are illustrated. More specifically, polymer organic compounds having a benzene ring optionally having a substituent, polymer organic compounds having a structure of the following general formula (6), and the like are mentioned. Further, for example, polymer organic compounds described in JP-A No. 2003-231741, JP-A No. 2004-059899, JP-A No. 2004-002654, JP-A No. 2004-292546, U.S. Pat. No. 5,708,130, WO 9954385, WO 0046321, WO 02077060, “Organic EL Display” (Shizuo Tokito, Chihaya Adachi, Hideyuki Murata joint work, Ohmsha, Ltd.) p. 111, Monthly Display, vol. 9, No. 9, 2002, p. 47-51, and the like are mentioned.

“Conjugated polymer” is a molecule containing multiple bonds and single bonds connected long repeatedly as described, for example, in “Yuki EL no hanashi” (edited by Katsumi Yoshino, Nikkan Kogyo Shimbun Ltd.) p. 23, and for example, polymers containing a repeating structure of the following structure, or a structure combining appropriately the following structures, are mentioned as typical example.

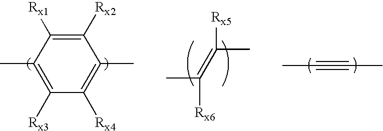

(wherein, R^{X1} to R^{X6} represent each independently an alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, silyloxy group or substituted silyloxy group.).

In the formulae, the groups represented by R^{X1} to R^{X6} are specifically the same as explained and illustrated as the substituent which can be carried on the cyclic structure (for example, Z₁ ring, Z₂ ring and the like) contained in a ligand constituting a metal complex of the present invention described above.

Specific examples of the polymer organic compound include those containing the following group (namely, the following example deprived of parentheses), and those containing the following structure as a repeating unit.

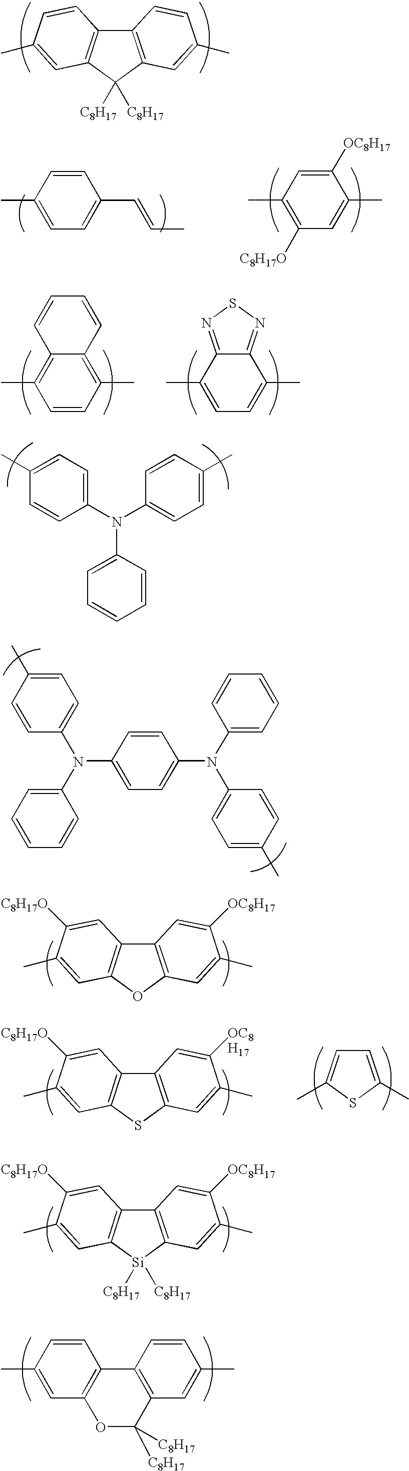

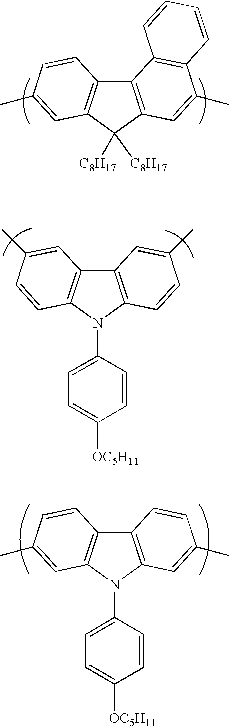

and the like are mentioned.

It is preferable that energy ESH (eV) of the low molecular weight organic compound or polymer organic compound in the ground state, energy ETH (eV) of the low molecular weight organic compound or polymer organic compound in the lowest excited triplet state, energy ESMC (eV) of the metal complex in the ground state, and energy ETMC (eV) of the metal complex in the lowest excited triplet state satisfy a relation of:

ETH(eV)−ESH(eV)>ETMC(eV)−ESMC(eV)−0.2(eV).

The above-described polymer organic compound has a polystyrene-reduced number average molecular weight of 10³ to 10⁸, preferably 10⁴ to 10⁶. This polymer organic compound has a polystyrene-reduced weight average molecular weight of 10³ to 108, preferably 5×10⁴ to 5×10⁶.

As the above-described light emitting material, known materials can be used. As the light emitting material, low molecular weight light emitting materials such as, for example, naphthalene derivatives, anthracene or derivatives thereof, perylene or derivatives thereof, coloring matters of polymethine, xanthene, coumarine and cyanine type and the like, metal complexes of 8-hydroxyquinoline or derivatives thereof, aromatic amines, tetraphenylcyclopentadiene or derivatives thereof, or tetraphenylbutadiene or derivatives thereof, and the like are mentioned.

The compounding amount of the above-described metal complex in a composition of the present invention is not particularly restricted since it varies depending the kind of an organic compound to be combined, and a property which is wished to be optimized, and if the amount of an organic compound (namely, polymer organic compound and/or low molecular weight organic compound) is hypothesized to be 100 parts by weight, the compounding amount it usually 0.01 to 80 parts by weight, preferably 0.1 to 60 parts by weight. The above-described metal complexes may be used singly or compounded in combination.

### <Liquid Composition>

The metal complex, polymer compound and composition of the present invention are all useful for manufacturing of devices such as a photoelectric device, light emitting device and the like, and particularly, it is preferable to mix the metal complex, polymer compound and composition with a solvent or dispersing medium to give a liquid composition to be used (for example, used as a solution in a printing method or the like). Here, the “liquid composition” means a composition which is liquid in manufacturing of a device, and typically, a composition which is liquid at normal pressure (namely, 1 atom) and 25° C. By thus giving a liquid composition, a layered structure, film and the like can be formed easily in devices such as a photoelectric device, light emitting device and the like. That is, a layered structure, film and the like can be formed only by applying the above-described liquid composition, and thereafter, drying this to remove a solvent.

The film formation method from a liquid composition (hereinafter, referred to as “film formation from solution”) includes application methods such as a spin coat method, casting method, micro gravure coat method, gravure coat method, bar coat method, roll coat method, wire bar coat method, dip coat method, spray coat method, screen printing method, flexo printing method, offset printing method, inkjet print method, nozzle coat method, capillary coat method, dispenser method and the like.

The above-described liquid composition may contain, additionally, a charge transporting material, light emitting material, stabilizer, additives for adjusting viscosity and/or surface tension, additives such as an antioxidant, and the like.

Of all solid components contained in the liquid composition, the proportion of a metal complex of the present invention and/or a polymer compound of the present invention is usually 20 wt % to 100 wt %, preferably 40 wt % to 100 wt %.

The proportion of a solvent or dispersing medium in the above-described liquid composition is usually from 1 wt % to 99.9 wt %, preferably 60 wt % to 99.9 wt %, further preferably 90 wt % to 99.8 wt %, with respect to the total weight of the liquid composition.

The viscosity of the above-described liquid composition varies depending on the printing method, and it is preferably in the range of from 0.5 to 500 mPa·s at 25° C., and in the case of a liquid composition passing through a discharging apparatus such as in an inkjet print method and the like, the viscosity is preferably in the range of 0.5 to 20 mPa·s at 25° C. for preventing clogging in discharging and curving in flying.

As the solvent and dispersing medium to be used in the liquid composition, those capable of dissolving or uniformly dispersing a metal complex and a polymer compound of the present invention are preferable. Examples of the solvent and dispersing agent include chlorine-based solvents such as chloroform, methylene chloride, 1,2-dichloroethane, 1,1,2-trichloroethane, chlorobenzene, o-dichlorobenzene and the like, ether solvents such as tetrahydrofuran, dioxane and the like, aromatic hydrocarbon solvents such as toluene, xylene, trimethylbenzene, mesitylene and the like, aliphatic hydrocarbon solvents such as cyclohexane, methylcyclohexane, n-pentane, n-hexane, n-heptane, n-octane, n-nonane, n-decane and the like, ketone solvents such as acetone, methyl ethyl ketone, cyclohexanone and the like, ester solvents such as ethyl acetate, butyl acetate, methyl benzoate, ethylcellosolve acetate and the like, polyhydric alcohols such as ethylene glycol, ethylene glycol monobutyl ether, ethylene glycol monoethyl ether, ethylene glycol monomethyl ether, dimethoxyethane, propylene glycol, diethoxymethane, triethylene glycol monoethyl ether, glycerine, 1,2-hexanediol and the like and derivatives thereof, alcohol solvents such as methanol, ethanol, propanol, isopropanol, cyclohexanol and the like, sulfoxide solvents such as dimethyl sulfoxide and the like, amide solvents such as N-methyl-2-pyrrolidone, N,N-dimethylformamide and the like, and so forth. Of them, preferable from the standpoints of solubility in a solvent, uniformity in film formation, viscosity property and the like of a metal complex and a polymer compound of the present invention are aromatic hydrocarbon solvents, aliphatic hydrocarbon solvents, ester solvents and ketone solvents, and toluene, xylene, ethylbenzene, diethylbenzene, trimethylbenzene, mesitylene, n-propylbenzene, i-propylbenzene, n-butylbenzene, i-butylbenzene, s-butylbenzene, anisole, ethoxybenzene, 1-methylnaphthalene, cyclohexane, cyclohexanone, cyclohexylbenzene, bicyclohexyl, cyclohexenylcyclohexanone, n-heptylcyclohexane, n-hexylcyclohexane, methyl benzoate, 2-propylcyclohexanone, 2-heptanone, 3-heptanone, 4-heptanone, 2-octanone, 2-nonanone, 2-decanone and dicyclohexyl ketone are preferable, and xylene, anisole, mesitylene, cyclohexylbenzene and bicyclohexyl methyl benzoate are particularly preferable.

These solvents and dispersing media may be used singly or in combination of two or more. Of the above-described solvents and dispersing media, at least one organic solvent having a structure containing at least one benzene ring and having a melting point of 0° C. or lower and a boiling point of 100° C. of higher is particularly preferably contained.

The number of solvents to be contained in the above-described liquid composition is preferably 2 or more, more preferably 2 to 3, further preferably 2, from the standpoints of film formability, device properties and the like.

When two solvents are contained in the above-described liquid composition, one of them may be solid at 25° C. From the standpoint of film formability, it is preferable that one solvent is a solvent having a boiling point of 180° C. or higher, and another solvent is a solvent having a boiling point of lower than 180° C., and it is more preferable that one solvent is a solvent having a boiling point of 200° C. or higher, and another solvent is a solvent having a boiling point of lower than 180° C. From the standpoint of viscosity, it is preferable that a metal complex and a polymer compound of the present invention are dissolved in an amount of 0.2 wt % or more at 60° C. in both of the two solvents, and it is preferable that a metal complex and a polymer compound of the present invention are dissolved in an amount of 0.2 wt % or more at 25° C. in one of the two solvents.

When three solvents are contained in the above-described liquid composition, one or two solvents may be solid at 25° C. From the standpoint of film formability, it is preferable that at least one of the three solvents is a solvent having a boiling point of 180° C. or higher and at least one solvent is a solvent having a boiling point of lower than 180° C., and it is more preferable that at least one of the three solvents is a solvent having a boiling point of 200° C. or higher and 300° C. or lower and at least one solvent is a solvent having a boiling point of lower than 180° C. From the standpoint of viscosity, it is preferable that a metal complex and a polymer compound of the present invention are dissolved in an amount of 0.2 wt % or more at 60° C. in two of the three solvents, and it is preferable that a metal complex and a polymer compound of the present invention are dissolved in an amount of 0.2 wt % or more at 25° C. in one of the three solvents.

When two or more solvents are contained in the above-described liquid composition, the content of a solvent having the highest boiling point is preferably 40 to 90 wt %, more preferably 50 to 90 wt %, further preferably 65 to 85 wt % based on the weight of all solvents in the liquid composition from the standpoints of viscosity and film formability.

As the above-described liquid composition, preferable from the standpoints of viscosity and film formability are a liquid composition containing anisole and bicyclohexyl, a liquid composition containing anisole and cyclohexylbenzene, a liquid composition containing xylene and bicyclohexyl, a liquid composition containing xylene and cyclohexylbenzene, and a liquid composition containing mesitylene and methyl benzoate.

As the hole transporting material and electron transporting material among additives which can be contained in the above-described liquid composition, compounds described above are mentioned as examples thereof. The light emitting material is the same as explained and illustrated above.

As the stabilizer, phenol antioxidants, phosphorus-based antioxidants and the like are mentioned.

As the additives for adjusting viscosity and/or surface tension, a thickening agent of high molecular weight for enhancing viscosity, a poor solvent, a compound of low molecular weight for decreasing viscosity, a surfactant for decreasing surface tension, and the like can be appropriately combined and used.

As the above-described thickening agent of high molecular weight, those soluble in the same solvent as for a metal complex and a polymer compound of the present invention and not disturbing light emission and charge transportation may be permissible. For example, polystyrene of high molecular weight, polymethyl methacrylate of high molecular weight, polymer compounds of the present invention having higher molecular weight, and the like can be used.

As the above-described thickening agent of high molecular weight, those having a polystyrene-reduced number average molecular weight of 500000 or more are preferable, and those of 1000000 or more are more preferable. A poor solvent can also be used as the thickening agent. That is, by adding a small amount of poor solvent for solid components in the liquid composition, viscosity can be enhanced. If also stability in preservation is taken into consideration, the amount of a poor solvent is preferably 50 wt % or less, further preferably 30 wt % or less with respect to the whole liquid composition.

As the antioxidant, those soluble in the same solvent as for a metal complex and a polymer compound of the present invention and not disturbing light emission and charge transportation may be permissible, and illustrated are phenol antioxidants, phosphorus-based antioxidants and the like. By using the antioxidant, the preservation stability of the above-described liquid composition can be improved.

When a solvent is contained as one component of the liquid composition, a difference between the solubility parameter of a solvent and the solubility parameter of a polymer compound is preferably 10 or less, more preferably 7 or less, from the standpoint of solubility of a metal complex and a polymer compound of the present invention in a solvent. The solubility parameter of a solvent and the solubility parameter of a polymer material of the present invention can be measured by a method described in “Solvent Handbook (Kodansha, 1976)”.

A metal complex and/or polymer compound of the present invention may be contained singly or in combination of two or more in the above-described liquid composition, and a compound of high molecular weight other than the metal complex and polymer compound of the present invention may also be contained in a range not deteriorating device properties and the like.

### <Device>

Next, the device of the present invention will be explained. The device of the present invention is characterized in that a layer containing a metal complex of the present invention and/or a polymer compound of the present invention (here, the metal complex and polymer compound may be present as they are alternatively, prepared as the above-described composition, being applicable also in the following descriptions) is present between electrodes composed of an anode and a cathode, and can be used as photoelectric devices such as, for example, light emitting devices, switching devices (for example, useful in display), photoelectric conversion devices (for example, useful for solar battery), and the like. When the devices is a light emitting device, it is preferable that the layer containing a metal complex of the present invention and/or a polymer compound of the present invention is a light emitting layer.

### —Light Emitting Device—

The light emitting device of the present invention includes 1) a light emitting device having an electron transporting layer provided between a cathode and a light emitting layer, 2) a light emitting device having a hole transporting layer provided between an anode and a light emitting layer, 3) a light emitting device having an electron transporting layer provided between a cathode and a light emitting layer, and having a hole transporting layer provided between an anode and a light emitting layer, and the like. The light emitting device of the present invention may further have a charge blocking layer, and for example, a hole blocking layer may be present between a light emitting layer and a cathode.

The light emitting layer is a layer having a function of emitting light, the hole transporting layer is a layer having a function of transporting holes, and the electron transporting layer is a layer having a function of transporting electrons. The electron transporting layer and hole transporting layer are collectively called a charge transporting layer. The charge blocking layer means a layer having a function of confining holes or electrons in a light emitting layer, and a layer transporting electrons and confining holes is called a hole blocking layer, and a layer transporting holes and confining electrons is called an electron blocking layer.

The light emitting device of the present invention includes, additionally, a light emitting device having, between a light emitting layer and at least one electrode described above, a layer containing an electric conductive layer provided next to the electrode; a light emitting device having, between a light emitting layer and at least one electrode, a buffer layer having an average thickness of 2 nm or less provided next to the electrode; and the like.

Specifically, the following structures a) to e) are illustrated.

a) anode/light emitting layer/cathode
b) anode/hole transporting layer/light emitting layer/cathode
c) anode/light emitting layer/electron transporting layer/cathode
d) anode/light emitting layer/hole blocking layer/cathode
e) anode/hole transporting layer/light emitting layer/electron transporting layer/cathode
(wherein,/represents adjacent lamination of layers, being applicable also in the following descriptions.).

Two or more light emitting layers, two or more hole transporting layers and two or more electron transporting layers may be used each independently.

The light emitting device of the present invention includes also devices in which a metal complex of the present invention and/or a polymer compound of the present invention is contained in a hole transporting layer and/or an electron transporting layer.

When a metal complex of the present invention and/or a polymer compound of the present invention is used in a hole transporting layer, it is preferable that a metal complex of the present invention and/or a polymer compound of the present invention contains a hole transporting group, and as specific examples thereof, copolymers with an aromatic amine, copolymers with stilbene, and the like are mentioned. When a metal complex of the present invention and/or a polymer compound of the present invention is used in an electron transporting layer, it is preferable that a metal complex of the present invention and/or a polymer compound of the present invention contains an electron transporting group, and as specific examples thereof, copolymers with oxadiazole, copolymers with triazole, copolymers with quinoline, copolymers with quinoxaline, copolymers with benzothiadiazole, and the like are mentioned.

When the light emitting device of the present invention has a hole transporting layer (usually, the hole transporting layer contains a hole transporting material), illustrated as the hole transporting material to be used are polymer hole transporting materials such as polyvinylcarbazole or derivatives thereof, polysilane or derivatives thereof, polysiloxane derivatives having an aromatic amine on the side chain or main chain, pyrazoline derivatives, arylamine derivatives, stilbene derivatives, triphenyldiamine derivatives, polyaniline or derivatives thereof, polythiophene or derivatives thereof, polypyrrole or derivatives thereof, poly(p-phenylenevinylene) or derivatives thereof, or poly(2,5-thienylenevinylene) or derivatives thereof, and the like.

Specifically illustrated as the hole transporting material are those described in JP-A Nos. 63-70257, 63-175860, 2-135359, 2-135361, 2-209988, 3-37992 and 3-152184, and the like.

Of them, preferable as the hole transporting material used in the hole transporting layer are polymer hole transporting materials such as polyvinylcarbazole or derivatives thereof, polysilane or derivatives thereof, polysiloxane derivatives having an aromatic amine group on the side chain or main chain, polyaniline or derivatives thereof, polythiophene or derivatives thereof, poly(p-phenylenevinylene) or derivatives thereof, or poly(2,5-thienylenevinylene) or derivatives thereof, and the like, and further preferable are polyvinylcarbazole or derivatives thereof, polysilane or derivatives thereof, and polysiloxane derivatives having an aromatic amine on the side chain or main chain.

Examples of the low molecular weight hole transporting material include pyrazoline derivatives, arylamine derivatives, stilbene derivatives, and triphenyldiamine derivatives. In the case of the low molecular weight hole transporting material, it is preferably dispersed in a polymer binder.

As the polymer binder to be mixed, those not extremely disturbing charge transportation are preferable, and those showing no intense absorption against visible light are suitably used. Examples of the polymer binder include poly (N-vinylcarbazole), polyaniline or derivatives thereof, polythiophene or derivatives thereof, poly(p-phenylenevinylene) or derivatives thereof, poly(2,5-thienylenevinylene) or derivatives thereof, polycarbonate, polyacrylate, polymethyl acrylate, polymethyl methacrylate, polystyrene, polyvinyl chloride, polysiloxane and the like.

Polyvinylcarbazole or derivatives thereof are obtained, for example, by cation polymerization or radical polymerization from vinyl monomers.

Examples of the polysilane or derivatives thereof include compounds described in Chem. Rev. vol. 89, p. 1359 (1989), GB 2300196, and the like. Also as the synthesis method thereof, methods described in them can be used, and particularly, the Kipping method is suitably used.

Since polysiloxane or derivatives thereof have little hole transportability in the siloxane skeleton structure, those having a structure of the above-described low molecular weight hole transporting material on the side chain or main chain are suitably used. Particularly, those having a hole transportable aromatic amine on the side chain or main chain are illustrated.

Though the method of film formation of a hole transporting layer is not restricted, a method of film formation from a mixed solution with a polymer binder is illustrated, in the case of a low molecular weight hole transporting material. In the case of a polymer hole transporting material, a method of film formation from a solution is illustrated.

The solvent to be used for film formation from a solution is not particularly restricted providing it dissolves a hole transporting material and a polymer binder. Examples of the solvent include chlorine-based solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, and ester solvents such as ethyl acetate, butyl acetate, ethylcellosolve acetate and the like.

As the film formation method from a solution, application methods from a solution such as a spin coat method, casting method, micro gravure coat method, gravure coat method, bar coat method, roll coat method, wire bar coat method, dip coat method, spray coat method, screen printing method, flexo printing method, offset printing method, inkjet print method, nozzle coat method, capillary coat method, dispenser method and the like can be used.

The thickness of a hole transporting layer shows an optimum value varying depending on the material to be used, and may be advantageously selected so as to give suitable values of driving voltage and light emission efficiency, and at least thickness causing no generation of pin holes is necessary, and when too thick, the driving voltage of the device increases undesirably. Therefore, the thickness of the hole transporting layer is, for example, 1 nm to 1 μm, preferably 2 nm to 500 nm, further preferably 5 nm to 200 nm.

When the light emitting device of the present invention has an electron transporting layer (usually, the electron transporting layer contains an electron transporting material), known materials can be used as the electron transporting material to be used, and examples include oxadiazole derivatives, anthraquinodimethane or derivatives thereof, benzoquinone or derivatives thereof, naphthoquinone or derivatives thereof, anthraquinone or derivatives thereof, tetracyanoanthraquinodimethane or derivatives thereof, fluorenone derivatives, diphenyldicyanoethylene or derivatives thereof, diphenoquinone derivatives, or metal complexes of 8-hydroxyquinoline or derivatives thereof, polyquinoline or derivatives thereof, polyquinoxaline or derivatives thereof, polyfluorene or derivatives thereof, and the like.

Specific examples are those described in JP-A Nos. 63-70257, 63-175860, 2-135359, 2-135361, 2-209988, 3-37992 and 3-152184, and the like.

Of them, preferable are oxadiazole derivatives, benzoquinone or derivatives thereof, anthraquinone or derivatives thereof, or metal complexes of 8-hydroxyquinoline or derivatives thereof, polyquinoline or derivatives thereof, polyquinoxaline or derivatives thereof, and polyfluorene or derivatives thereof, and further preferable are 2-(4-biphenylyl)-5-(4-t-butylphenyl)-1,3,4-oxadiazole, benzoquinone, anthraquinone, tris(8-quinolinol)aluminum and polyquinoline.

The method of film formation of an electron transporting layer is not particularly restricted, and a vacuum vapor deposition method from a powder, or a method of film formation from solution or melted state is illustrated in the case of a low molecular weight electron transporting material, and a method of film formation from solution or melted state is illustrated in the case of a polymer electron transporting material, respectively. In film formation from solution or melted state, the above-described polymer binder may be used together.

The solvent to be used for film formation from a solution is not particularly restricted providing it dissolves an electron transporting material and a polymer binder. Examples of the solvent include chlorine-based solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, and ester solvents such as ethyl acetate, butyl acetate, ethylcellosolve acetate and the like.

As the film formation method from solution or melted state, application methods such as a spin coat method, casting method, micro gravure coat method, gravure coat method, bar coat method, roll coat method, wire bar coat method, dip coat method, spray coat method, screen printing method, flexo printing method, offset printing method, inkjet print method, nozzle coat method, capillary coat method, dispenser method and the like can be used.

The thickness of an electron transporting layer shows an optimum value varying depending on the material to be used, and may be advantageously selected so as to give suitable values of driving voltage and light emission efficiency, and at least thickness causing no generation of pin holes is necessary, and when too thick, the driving voltage of the device increases undesirably. Therefore, the thickness of the electron transporting layer is, for example, from 1 nm to 1 μm, preferably 2 nm to 500 nm, further preferably 5 nm to 200 nm.

Charge transporting layers placed next to an electrode, having a function of improving charge injection efficiency from an electrode and having an effect of decreasing the driving voltage of the device, are in general called particularly a charge injection layer (namely, generic name for hole injection layer and electron injection layer, being applicable also in the following descriptions) in some cases.

Further, for improvement of close adherence with an electrode and improvement in charge injection from an electrode, the above-described charge injection layer or insulation layer may be placed next to an electrode, alternatively, for improvement of close adherence of an interface and prevention of mixing and the like, a thin buffer layer may be inserted in the interface of a charge transporting layer and a light emitting layer.

The order and number of layers to be laminated, and the thickness of each layer can be appropriately determined in view of light emission efficiency and device life.

In the present invention, the light emitting device having a charge injection layer provided includes a light emitting device having a charge injection layer placed next to a cathode, a light emitting device having a charge injection layer placed next to an anode, and the like.

For example, the following structures f) to q) are specifically mentioned.

f) anode/charge injection layer/light emitting layer/cathode
g) anode/light emitting layer/charge injection layer/cathode
h) anode/charge injection layer/light emitting layer/charge injection layer/cathode
i) anode/charge injection layer/hole transporting layer/light emitting layer/cathode
j) anode/hole transporting layer/light emitting layer/charge injection layer/cathode
k) anode/charge injection layer/hole transporting layer/light emitting layer/charge injection layer/cathode
l) anode/charge injection layer/light emitting layer/electron transporting layer/cathode
m) anode/light emitting layer/electron transporting layer/charge injection layer/cathode
n) anode/charge injection layer/light emitting layer/electron transporting layer/charge injection layer/cathode
o) anode/charge injection layer/hole transporting layer/light emitting layer/electron transporting layer/cathode
p) anode/hole transporting layer/light emitting layer/electron transporting layer/charge injection layer/cathode
q) anode/charge injection layer/hole transporting layer/light emitting layer/electron transporting layer/charge injection layer/cathode

Specific examples of the charge injection layer include a layer containing an electric conductive polymer, a layer placed between an anode and a hole transporting layer and containing a material having ionization potential of a value between an anode material and a hole transporting material contained in a hole transporting layer, a layer placed between an anode and an electron transporting layer and containing a material having electron affinity of a value between a cathode material and an electron transporting material contained in an electron transporting layer, and the like.

When the above-described charge injection layer is a layer containing an electric conductive polymer, electric conductivity of the electric conductive polymer is preferably 10⁻⁵ S/cm or more and 10³ S/cm or less, and for decreasing leak current between light emission picture elements, more preferably 10⁻⁵ S/cm or more and 10² S/cm or less, further preferably 10⁻⁵ S/cm or more and 10¹ S/cm or less.

Usually, for controlling the electric conductivity of the electric conductive polymer to 10⁻⁵ S/cm or more and 10³ S/cm or less, the electric conductive polymer is doped with a suitable amount of ions.

As the kind of ions to be doped, an anion is used in a hole injection layer and a cation is used in an electron injection layer. Examples of the anion include a polystyrenesulfonic ion, alkylbenzenesulfonic ion, camphorsulfonic ion and the like, and examples of the cation include a lithium ion, sodium ion, potassium ion, tetrabutylammonium ion and the like.

The thickness of the charge injection layer is, for example, 1 nm to 100 nm, preferably 2 nm to 50 nm.

The material used in the charge injection layer may be appropriately selected depending on a relation with the material of an electrode and an adjacent layer, and illustrated are polyaniline and its derivatives, polythiophene and its derivatives, polypyrrole and its derivatives, polyphenylenevinylene and its derivatives, polythienylenevinylene and its derivatives, polyquinoline and its derivatives, polyquinoxaline and its derivatives, electric conductive polymers such as polymers containing an aromatic amine structure on the side chain or main chain, metal phthalocyanine (copper phthalocyanine and the like), carbon and the like.

An insulation layer has a function of making charge injection easier. The insulation layer has an average thickness of preferably 4 nm or less, more preferably 2 nm or less. Usually, the lower limit of the average thickness is 0.5 nm. As the material of the above-described insulation layer, a metal fluoride, metal oxide, organic insulating material and the like are mentioned. The light emitting device having an insulation layer provided includes a light emitting device having an insulation layer placed next to a cathode, and a light emitting device having an insulation layer placed next to an anode.

Specifically, the following structures r) to ac) are mentioned, for example.

r) anode/insulation layer/light emitting layer/cathode
s) anode/light emitting layer/insulation layer/cathode
t) anode/insulation layer/light emitting layer/insulation layer/cathode
u) anode/insulation layer/hole transporting layer/light emitting layer/cathode
v) anode/hole transporting layer/light emitting layer/insulation layer/cathode
w) anode/insulation layer/hole transporting layer/light emitting layer/insulation layer/cathode
x) anode/insulation layer/light emitting layer/electron transporting layer/cathode
y) anode/light emitting layer/electron transporting layer/insulation layer/cathode
z) anode/insulation layer/light emitting layer/electron transporting layer/insulation layer/cathode
aa) anode/insulation layer/hole transporting layer/light emitting layer/electron transporting layer/cathode
ab) anode/hole transporting layer/light emitting layer/electron transporting layer/insulation layer/cathode
ac) anode/insulation layer/hole transporting layer/light emitting layer/electron transporting layer/insulation layer/cathode

The substrate for forming a light emitting device of the present invention may advantageously be one which does not change in forming an electrode and forming a layer of an organic material, and examples thereof include glass, plastic, polymer film, silicon substrate and the like. In the case of an opaque substrate, it is preferable that the opposite electrode is transparent or semi-transparent.

Usually, at least one of an anode and a cathode contained in a light emitting device of the present invention is transparent or semi-transparent. It is preferable that a cathode is transparent or semi-transparent.

As the material of the cathode, an electric conductive metal oxide film, semi-transparent metal thin film and the like are used. Specifically, films (NESA and the like) formed using electric conductive glass composed of indium oxide, zinc oxide, tin oxide, and composite thereof: indium-tin-oxide (ITO), indium-zinc-oxide and the like, gold, platinum, silver, copper and the like are used, and ITO, indium-zinc-oxide, tin oxide are preferable. As the manufacturing method, a vacuum vapor-deposition method, sputtering method, ion plating method, plating method and the like are mentioned. As the anode, organic transparent electric conductive films made of polyaniline or its derivative, polythiophene or its derivative, and the like may be used.

The thickness of an anode can be appropriately selected in view of light transmission and electric conductivity, and it is, for example, 10 nm to 10 μm, preferably 20 nm to 1 μm, further preferably 50 nm to 500 nm.

For making charge injection easier, a layer made of a phthalocyanine derivative, electric conductive polymer, carbon and the like, or a layer having an average thickness of 2 nm or less made of a metal oxide, metal fluoride, organic insulation material and the like, may be placed on an anode.

As the material of a cathode used in a light emitting device of the present invention, materials of small work function are preferable. For example, metals such as lithium, sodium, potassium, rubidium, cesium, beryllium, magnesium, calcium, strontium, barium, aluminum, scandium, vanadium, zinc, yttrium, indium, cerium, samarium, europium, terbium, ytterbium and the like, alloys made of two or more of them, or alloys made of at least one of them and at least one of gold, silver, platinum, copper, manganese, titanium, cobalt, nickel, tungsten and tin, graphite or graphite intercalation compounds and the like are used. Examples of the alloy include magnesium-silver alloy, magnesium-indium alloy, magnesium-aluminum alloy, indium-silver alloy, lithium-aluminum alloy, lithium-magnesium alloy, lithium-indium alloy, calcium-aluminum alloy and the like. The cathode may take a laminated structure including two or more layers.

The thickness of a cathode can be appropriately selected in view of electric conductivity and durability, and it is, for example, 10 nm to 10 μm, preferably 20 nm to 1 μm, further preferably 50 nm to 500 nm.

As the cathode manufacturing method, a vacuum vapor-deposition method, sputtering method, lamination method of thermally press-bonding a metal thin film, and the like are used. A layer made of an electric conductive polymer, or a layer having an average thickness of 2 nm or less made of a metal oxide, metal fluoride, organic insulation material and the like, may be placed between a cathode and an organic material layer, and after manufacturing a cathode, a protective layer for protecting the light emitting device may be installed. For use of the light emitting device stably for a long period of time, it is preferable to install a protective layer and/or protective cover, for protecting a device from outside.

As the protective layer, a polymer compound, metal oxide, metal fluoride, metal boride and the like can be used. As the protective cover, a glass plate, and a plastic plate having a surface subjected to low water permeation treatment, and the like can be used, and a method of pasting the cover to a device substrate with a thermosetting resin or photo-curable resin to attain close sealing is suitably used. When a space is maintained using a spacer, prevention of blemishing of a device is easier. If an inert gas such as nitrogen, argon and the like is filled in this space, oxidation of a cathode can be prevented, further, by placing a drying agent such as barium oxide and the like in this space, it becomes easier to suppress moisture adsorbed in a production process from imparting damage to the device. It is preferable to adopt one strategy among these methods.

The light emitting device of the present invention can be used as a sheet light source, display (for example, segment display, dot matrix display, liquid crystal display and the like) and back light thereof, and the like.

For obtaining light emission in the form of sheet using a light emitting device of the present invention, it may be advantages to place a sheet anode and a sheet cathode so as to overlap. For obtaining light emission in the form of pattern, there are a method in which a mask having a window in the form of pattern is placed on the surface of the above-described sheet light emitting device, a method in which an organic material layer in non-light emitting parts is formed with extremely large thickness to give substantially no light emission, a method in which either anode or cathode, or both electrodes are formed in the form pattern. By forming a pattern by any of these methods, and placing several electrodes so that On/Off is independently possible, a display of segment type is obtained which can display digits, letters, simple marks and the like. Further, for providing a dot matrix device, it may be advantageous that both an anode and a cathode are formed in the form of stripe, and placed so as to cross. By using a method in which several polymer fluorescent bodies showing different emission colors are painted separately or a method in which a color filter or a fluorescence conversion filter is used, partial color display and multi-color display are made possible. In the case of a dot matrix device, passive driving is possible, and active driving may also be carried out in combination with TFT and the like. These displays can be used as a display of a computer, television, portable terminal, cellular telephone, car navigation, view finder of video camera, and the like.

Further, the above-described sheet light emitting device is of self emitting and thin type, and can be suitably used as a sheet light source for back light of a liquid crystal display, or as a sheet light source for illumination. If a flexible substrate is used, it can also be used as a curved light source or display.

### —Photoelectric Device—

A photoelectric device will be illustrated as another embodiment of the present invention.

As the photoelectric device, for example, photoelectric conversion devices are mentioned, and illustrated are a device in which a layer containing a metal complex of the present invention and/or a polymer compound of the present invention is placed between two electrodes at least one of which is transparent or semi-transparent, a device having a comb-shaped electrode formed on a layer containing a metal complex of the present invention and/or a polymer compound of the present invention formed on a substrate, and the like. For improving properties, fullerene, carbon nano tube and the like may be mixed.

As the method of producing a photoelectric conversion device, a method described in Japanese Patent No. 3146296 is illustrated. Specific examples are a method in which a layer (thin film) containing a metal complex of the present invention and/or a polymer compound of the present invention is formed on a substrate having a first electrode, and a second electrode is formed thereon, and a method in which a layer (thin film) containing a metal complex of the present invention and/or a polymer compound of the present invention is formed on a pair of comb-shaped electrodes formed on a substrate. One of the first and second electrodes is transparent or semi-transparent.

The method of forming a layer (thin film) containing a metal complex of the present invention and/or a polymer compound of the present invention and the method of mixing fullerene and carbon nano tube are not particularly restricted, and those illustrated for the light emitting device can be suitably used.

### <Other Applications>

The metal complex of the present invention and the polymer compound of the present invention are not only useful for manufacturing of devices as described above, but also can be used as, for example, semiconductor materials such as organic semiconductor materials and the like, light emitting materials, optical materials, or electric conductive materials (for example, applied by doping). Therefore, films such as light emitting films, electric conductive films, organic semiconductor films and the like can be manufactured using the metal complex and the polymer compound.

The metal complex of the present invention and the polymer compound of the present invention can be used to form an electric conductive thin film and a semiconductor thin film and to manufacture a device by the same manner as the method of producing a light emitting film to be used in a light emitting layer of the above-described light emitting device. In the semiconductor thin film, either larger one of electron mobility or hole mobility is preferably 10⁻⁵ cm²/V/sec. or more. The organic semiconductor film can be used in organic solar batteries, organic transistors and the like.

Examples will be shown below for illustrating the present invention further in detail, but the invention is not limited to them.

### EXAMPLE 1

### Synthesis of Metal Complex (MC1)

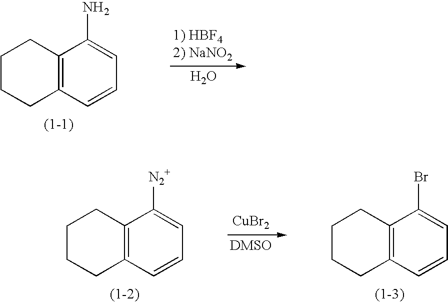

According to a method (scheme described above) described in J. Org. Chem. 1989, 54, 850-857, 1-bromo-5,6,7,8-tetrahydronaphthalene (1-3) was synthesized. Specifically, to a 42 wt % tetrafluoroboric acid aqueous solution cooled in an ice bath was slowly added 5,6,7,8-tetrahydro-1-naphthylamine (1-1), and subsequently, a sodium nitrite aqueous solution was dropped, and the resultant reaction mixture was washed with a 5 wt % tetrafluoroboric acid aqueous solution and water in this order to obtain a diazonium salt (1-2). To a dimethyl sulfoxide solution of copper (II) bromide was added the diazonium salt (1-2) and the mixture was stirred for 30 minutes, then, the reaction solution was diluted with water, and extracted with ethyl acetate. The resultant organic layer was concentrated, then, the residue was purified by silica gel chromatography, and the solvent was distilled off, to obtain 1-bromo-5,6,7,8-tetrahydronaphthalene (1-3).

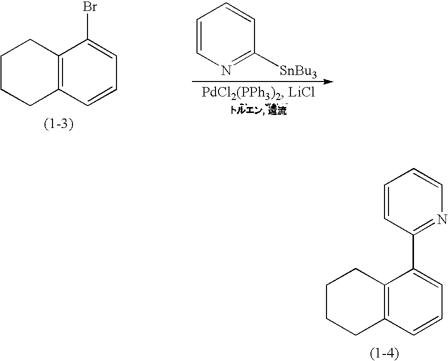

Into a reaction vessel, 1-bromo-5,6,7,8-tetrahydronaphthalene (1-3) (1.48 g, 7.0 mmol), tri-n-butyl(2-pyridyl)tin (3.76 g, 10 mmol), bis(triphenylphosphine)palladium (II) dichloride (0.337 g, 0.48 mmol), lithium chloride (1.70 g, 40 mmol) and toluene (35 mL) were weighed, and the mixture was refluxed for 6 hours under a nitrogen flow. After air-cooling, to the resultant reaction solution was added a potassium fluoride saturated aqueous solution (20 mL), and the mixture was stirred for 30 minutes at room temperature. The resultant reaction product was filtrated, and the filtrate was washed with a 5 wt % sodium hydrogen carbonate aqueous solution (200 mL), then, the organic layer was dried over sodium sulfate. The solvent was distilled off, and the residue was purified by silica gel column chromatography (hexane/diethyl ether), and the solvent was distilled off, to obtain 2-(5,6,7,8-tetrahydronaphthalen-1-yl)pyridine (1-4) (1.06 g, 5.1 mmol) as pale yellow oil. The yield was 73%.

LC-MS (positive) m/z: 210 ([M+H]⁺)

¹H NMR (300 MHz, CDCl₃)

d 1.77 (m, 4H), d 2.71 (m, 2H), d 2.86 (m, 2H), d 7.17 6 (m, 3H), d 7.22 (m, 1H), d 7.36 (m, 1H), d 7.72 (m, 1H), d 8.68 (m, 1H).

Under an inert gas atmosphere, 2-(5,6,7,8-tetrahydronaphthalen-1-yl)-pyridine and an iridium compound are charged, and reacted in an organic solvent. The resultant reaction product is subjected to a post treatment, to obtain a coarse product. This coarse product can be purified by column chromatography to obtain a metal complex (MC1).

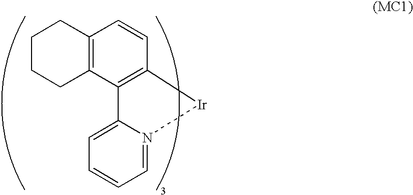

### —Calculation of Parameters—

For the metal complex (MC1), the dihedral angle (°) in a ligand of the metal complex (MC1), and the d orbital parameter F (%/eV) thereof were calculated by the following method. That is, the structure was optimized by a density functional approach of B3LYP level for the metal complex (MC1). In this procedure, LANL2DZ was used for the central metal iridium, and 6-31 G* was used for other atoms, as the basis function. Based on the optimized structure, the dihedral angle (°) in the ligand was calculated, and thereafter, the lowest singlet excitation energy S₁ (eV) and the lowest triplet excitation energy T₁ (eV) were calculated by a time-dependent density functional approach of B3LYP level using the same basis function, and the energy difference S₁−T₁ (eV) thereof was calculated. The results are shown in Table 1.

### —Manufacturing of EL Device and Evaluation of Properties—

An EL device using the metal complex (MC1) can be manufactured as described below. First, toluene solution A is prepared of a mixture obtained by mixing the metal complex (MC1) with a host compound such as 4,4′-bis(9-carbazolyl)biphenyl (CBP) and the like. Meanwhile, a film is formed using a solution of poly(ethylenedioxythiophene)/polystyrenesulfonic acid on a glass substrate with an ITO film, and dried. Next, the above-described toluene solution A is applied, to form a thin film. Further, this is dried, then, LiF as a cathode buffer layer, calcium as a cathode, then, aluminum is vapor-deposited in vacuum, to manufacture an EL device.

By applying voltage on this EL device, EL light emission can be confirmed. Properties such as luminance, light emission efficiency and the like can be measured by combining a luminance meter and a current-voltage meter.

### EXAMPLE 2

### Synthesis of Metal Complex (MC2)

Under an inert gas atmosphere, into a reaction vessel is charged 1-bromo-5,6,7,8-tetrahydronaphthalene and diethyl ether, and cooled. A hexane solution of n-butyllithium is dropped into this, and the mixture is stirred at low temperature. To this is added trimethoxyborane and the mixture is further stirred, then, hydrochloric acid is added. The reaction product is extracted with an organic solvent, and purified by column chromatography, thereby, 5,6,7,8-tetrahydronaphthalene-1-boric acid can be obtained.

Under an inert gas atmosphere, into a reaction vessel is charged 3-hydroxyisoquinoline and pyridine, and cooled. Trifluoromethanesulfonic anhydride is dropped, and the mixture is stirred while gradually raising temperature up to room temperature. The reaction product is subjected to a post-treatment, and purified by column chromatography, thereby, 3-{(trifluoromethanesulfonyl)oxy}isoquinoline can be obtained.

Under an inert gas atmosphere, a coupling reaction of 5,6,7,8-tetrahydronaphthalene-1-boric acid and 3-{(trifluoromethanesulfonyl)oxy}isoquinoline is carried out, to obtain a reaction product. This reaction product is subjected to a post-treatment, and purified by column chromatography, thereby, 3-(5,6,7,8-tetrahydronaphthalen-1-yl)isoquinoline can be obtained.

Under an inert gas atmosphere, 3-(5,6,7,8-tetrahydronaphthalen-1-yl)-isoquinoline and an iridium compound are charged, and reacted in an organic solvent. The resultant reaction product is subjected to a post treatment to obtain a coarse product. This coarse product can be purified by column chromatography to obtain a metal complex (MC2).

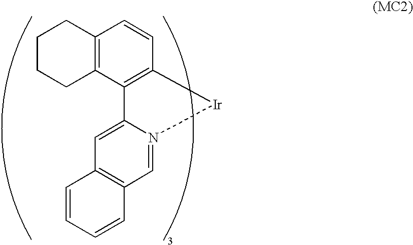

### —Calculation of Parameter—

According to the same manner as in Example 1, the dihedral angle (°) in a ligand of the metal complex (MC2), and the d orbital parameter F (%/eV) thereof were calculated. The results are shown in Table 1.

### —Manufacturing of EL Device and Evaluation of Properties—

An EL device can be manufactured in the same manner as in Example 1 excepting that the metal complex (MC2) is used instead of the metal complex (MC1) in Example 1. By applying voltage on this EL device, EL light emission can be confirmed. Properties such as luminance, light emission efficiency and the like can be measured by combining a luminance meter and a current-voltage meter.

### EXAMPLE 3

### Synthesis of metal complex MC3

According to the same manner as in Example 2,5,6,7,8-tetrahydronaphthalene-1-boric acid is synthesized.

Under an inert gas atmosphere, into a reaction vessel is charged 2-quinolinol and pyridine, and cooled. Trifluoromethanesulfonic anhydride is dropped, and the mixture is stirred while raising temperature gradually up to room temperature. The reaction product is subjected to a post treatment, and purified by column chromatography, thereby, 2-{(trifluoromethanesulfonyl)oxy}quinoline can be obtained.

Under an inert gas atmosphere, a coupling reaction of 5,6,7,8-tetrahydronaphthalene-1-boric acid and 2-{(trifluoromethanesulfonyl)oxy}quinoline is carried out, to obtain a reaction product. This reaction product is subjected to a post treatment, and purified by column chromatography, thereby, 2-(5,6,7,8-tetrahydronaphthalen-1-yl)quinoline can be obtained.

Under an inert gas atmosphere, 2-(5,6,7,8-tetrahydronaphthalen-1-yl)quinoline and an iridium compound are charged, and reacted in an organic solvent. The resultant reaction product is subjected to a post treatment to obtain a coarse product. This coarse product can be purified by column chromatography to obtain a metal complex (MC2).

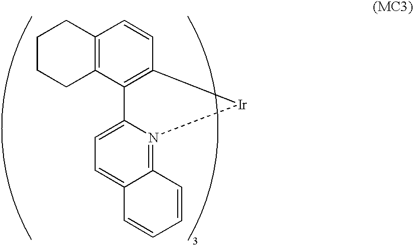

### —Calculation of Parameter—

According to the same manner as in Example 1, the dihedral angle (°) in a ligand of the metal complex (MC3), and the d orbital parameter F (%/eV) thereof were calculated. The results are shown in Table 1.

### —Manufacturing of EL Device and Evaluation of Properties—

An EL device can be manufactured in the same manner as in Example 1 excepting that the metal complex (MC3) is used instead of the metal complex (MC1) in Example 1. By applying voltage on this EL device, EL light emission can be confirmed. Properties such as luminance, light emission efficiency and the like can be measured by combining a luminance meter and a current-voltage meter.

TABLE 1

| | metal complex | dihedral angle (°) | F (%/eV) |
|---|---|---|---|
| Example 1 | MC1 | 9.5 | 221.96 |
| Example 2 | MC2 | 9.9 | 209.62 |
| Example 3 | MC3 | 11.0 | 268.33 |

### COMPARATIVE EXAMPLE 1

### Synthesis of Metal Complex (MC4)

A metal complex (MC4) was synthesized by a method described in J. Am. Chem. Soc., 2003, 125, 12971-12979.

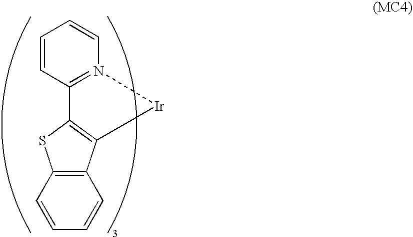

### —Calculation of Parameter—

According to the same manner as in Example 1, the dihedral angle (°) in a ligand of the above-described metal complex (MC4), and the d orbital parameter F (%/eV) thereof were calculated. The results are shown in Table 2.

A 10 wt % chloroform solution was prepared of a mixture obtained by mixing the above-described metal complex (MC4) and a polymethyl methacrylate resin (“Poly(methyl methacrylate), Typical Mw=120,000” manufactured by Aldrich, hereinafter, referred to as “PMMA”) at a weight ratio of 2:98. This solution was dropped on a quartz substrate, and dried, to form a PMMA film doped with the metal complex (MC4) on the quartz substrate. Using thus obtained substrate, photoluminescence was measured, to observe light emission having peaks at 608 nm and 657 nm, and the photoluminescence quantum yield was 27%. The photoluminescence quantum yield was measured at an excitation wavelength of 350 nm using an organic EL light emission property evaluation apparatus (manufactured by OPTEL K.K., trade name: IES-150).

### —Manufacturing of EL Device and Evaluation of Properties—

An EL device can be manufactured in the same manner as in Example 1 excepting that the metal complex (MC4) is used instead of the metal complex (MC1) in Example 1. By applying voltage on this EL device, EL light emission can be confirmed. Properties such as luminance, light emission efficiency and the like can be measured by combining a luminance meter and a current-voltage meter.

TABLE 2

| | metal complex | dihedral angle (°) | F (%/eV) |
|---|---|---|---|
| Comparative Example 1 | MC4 | 2.6 | 50.64 |

### EXAMPLE 4

### Synthesis of Metal Complex (MC5)

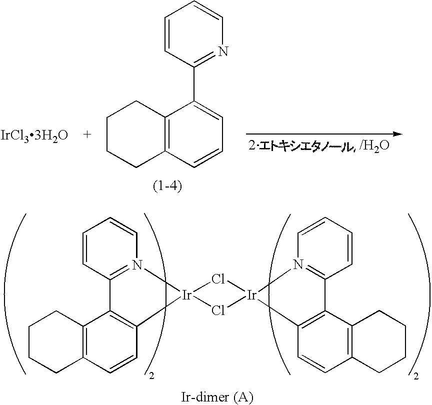

Into a reaction vessel, 2-(5,6,7,8-tetrahydronaphthalen-1-yl)pyridine (1-4) obtained in Example 1 (523 mg, 2.50 mmol), iridium chloride (IrCl₃.3H₂O) (401 mg, 1.14 mmol), 2-ethoxyethanol (6 mL) and water (2 mL) were weighed, and under a nitrogen flow, the mixture was refluxed at 140° C. for 7 hours. After air-cooling, the resultant reaction product was separated by filtration, and washed with water and methanol, to obtain Ir-dimer (A) as yellow solid (646 mg, 5.01 mmol). The yield was 88%.

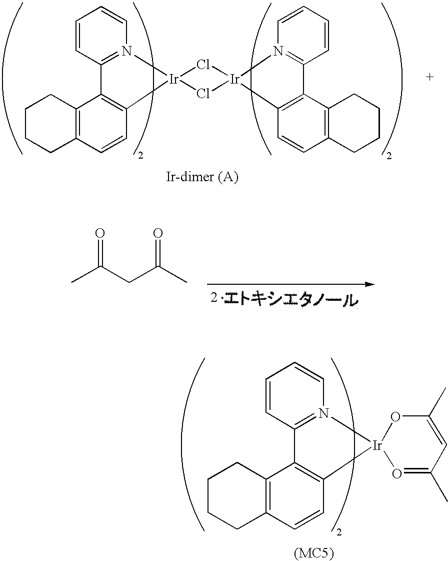

Into a reaction vessel, Ir-dimer (A) (387 mg, 0.30 mmol), acetylacetone (150 mg, 1.5 mmol), sodium carbonate (318 mg, 3.0 mmol) and 2-ethoxyethanol (8 mL) were weighed, and under a nitrogen flow, the mixture was stirred at room temperature for 22 hours. After air-cooling, the reaction product was separated by filtration, and washed with methanol and hexane. The resultant orange solid was dissolved in methylene chloride, and dried over sodium sulfate. The dried product was purified by silica gel column chromatography (methylene chloride), and concentrated until the solution amount reached about 2 mL. An orange crystal crystallized from the concentrated liquid was separated by filtration, and washed with hexane and diethyl ether, to obtain a yellow solid compound (MC5) (252 mg, 0.36 mmol). The yield was 59%.

LC-MS (positive) m/z: 709 ([M+H]⁺)

¹H NMR (300 MHz, CDCl₃) δ 1.75 (br, 14H), d 2.62 (br, 4H), d 3.16 (br, 4H), d 5.16 (d, 1H), d 5.98 (d, 2H), d 6.39 (dd, 2H), d 7.06 (m, 2H), d 7.68 (m, 2H), d 8.13 (d, 2H), d 8.62 (d, 2H).

### —Measurement of Photoluminescence Quantum Yield—

A 10 wt % chloroform solution was prepared of a mixture obtained by mixing the above-described metal complex (MC5) and a polymethyl methacrylate resin (manufactured by Aldrich, hereinafter, referred to as “PMMA”) at a weight ratio of 2:98. This solution was dropped on a quartz substrate, and dried, to form a PMMA film doped with the metal complex (MC5) on the quartz substrate. Using thus obtained substrate, photoluminescence was measured, to observe light emission having a peak at 562 nm, and the photoluminescence quantum yield was 67%. The photoluminescence quantum yield was measured at an excitation wavelength of 350 nm using an organic EL light emission property evaluation apparatus (manufactured by OPTEL K.K., trade name: IES-150).

### —Manufacturing of EL Device and Evaluation of Properties—

A 0.8 wt % chloroform solution was prepared of a mixture obtained by mixing a compound of the following formula:

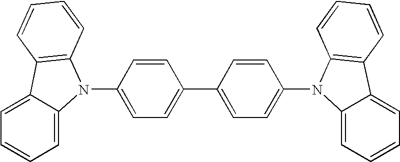

(CBP, manufactured by Dojin Kagaku Kenkyu sho) and the metal complex (MC5) at a weight ratio of 97.5:2.5.

Next, on a glass substrate carrying an ITO film formed thereon with a thickness of 150 nm by a sputtering method, a solution of poly(ethylenedioxythiophene)/polystyrenesulfonic acid (Bayer Corp., trade name: Baytron P) was spin-coated to form a film with a thickness of 50 nm, and dried at 200° C. for 10 minutes on a hot plate. Then, the chloroform solution prepared as described above was spin-coated at a revolution of 3500 rpm to form a film. Further, this was dried at 130° C. for 1 hour under a nitrogen gas atmosphere, then, as a cathode, barium was vapor-deposited with a thickness of about 5 nm, then, aluminum was vapor-deposited with a thickness of about 80 nm, to produce an EL device. Here, after the degree of vacuum reached 1×10⁻⁴ Pa or less, vapor-deposition of a metal was initiated.

By applying voltage on the resultant EL device, EL light emission was observed having a maximum peak at 550 nm. This EL device manifested an emission luminance of about 100 cd/m² at about 16 V, and the maximum light emission efficiency thereof was 15 cd/A.

### —Synthesis of Polymer Compound (P-1)—

Under an inert atmosphere, the following compound (M-1) [manufactured by Frontier Scientific] (0.392 g) and the following compound (M-2) (0.530 g) were dissolved in 8.5 mL of dehydrated toluene previously bubbled with argon. Next, the reaction mass was heated up to 45° C., and palladium acetate (0.4 mg) and phosphorus ligand (7 mg) were added, the mixture was stirred for 5 minutes, and 2.1 ml of a base was added, and the mixture was heated at 100° C. for 7 hours. To the resultant solution was added 4-tert butylphenylboric acid (0.05 g), and again, the mixture was heated at 100° C. for 2 hours. The reaction mixture was cooled, and methanol (155 ml) was poured into this, to obtain 0.47 g of the following polymer compound (P-1).

The polystyrene-reduced number average molecular weight and weight average molecular weight were Mn=1.1×10⁵ and Mw=2.5×10⁵, respectively (in the following formulae, n is the number of repeating units, satisfying these molecular weights.).

The polymer compound (P-1) was produced according to a method described in Japanese Patent Application National Publication (Laid-Open) No. 2005-506439.

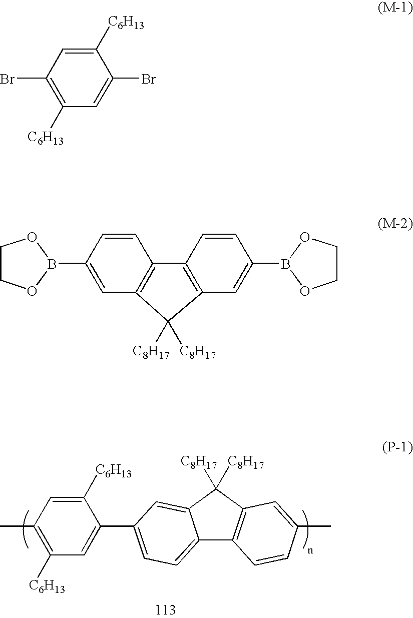

### —Manufacturing of EL Device and Evaluation of Properties 2—

A 0.4 wt % chloroform solution was prepared of a mixture obtained by mixing the above-described polymer compound (P-1) and the metal complex (MC5) at a weight ratio of 95:5, and this was spin-coated at a revolution of 2500 rpm to form a light emitting layer, and according to the same manner as described above, an EL device was manufactured.

By applying voltage on the resultant EL device, EL light emission was observed having a maximum peak at 550 nm. This EL device manifested an emission luminance of about 100 cd/m² at 19 V, and the maximum light emission efficiency thereof was 3 cd/A.

### EXAMPLE 5

### Synthesis of Metal Complex (MC6)

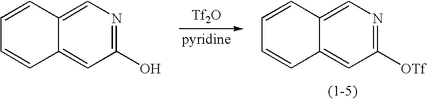

Into a reaction vessel, 3-hydroxyisoquinoline (5.0 g, 34.4 mmol) and dehydrated pyridine (15 mL) were weighed, and under a nitrogen flow, trifluoromethanesulfonic anhydride was dropped while cooling at 0° C. The mixture was reacted at 0° C. for 1 hour and at room temperature for 6 hours, then, water (100 ml) and diethyl ether (100 mL) were added, and the mixture was stirred at room temperature for 1 hour. The organic layer was washed with was (50 mL), 5 wt % hydrochloric acid (50 mL), water (50 mL) and saturated saline (50 mL) in this order, and dried over sodium sulfate. The solvent was distilled off, and the residue was purified by silica gel chromatography to obtain a compound (1-5) (8.44 g, 30.4 mmol). The yield was 88%.

LC-MS (positive) m/z: 278 ([M+H]⁺)

¹H NMR (300 MHz, CDCl₃)

δ 7.60 (s, 1H), δ 7.71 (m, 1H), δ 7.82 (m, 1H), δ 7.94 (d, J=8.3 Hz, 1H), 8.09 (d, J=8.3 Hz, 1H), 9.09 (s, 1

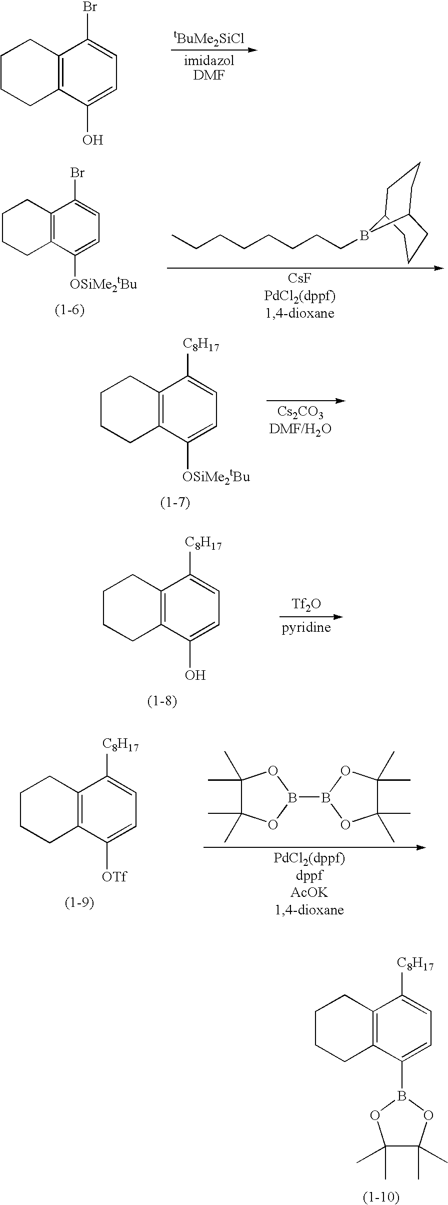

4-bromo-5,6,7,8-tetrahydro-1-naphthol was synthesized by a method described in Can. J. Chem., 1989, 69, 2061. Into a reaction vessel, 4-bromo-5,6,7,8-tetrahydro-1-naphthol (100.3 g, 442 mmol), imidazole (89.4 g, 1313 mmol) and N,N-dimethylformamide (1028 mL) were weighed under a nitrogen flow, and t-butyldimethylchlorosilane (91.9 g, 610 mmol) was added, and the mixture was stirred at room temperature for 89 hours. The reaction solution was poured into water (5 L), and extracted with ethyl acetate (2 L) twice. The organic layer was washed with water (1 L), and washed with saturated saline (1 L), then, dried over sodium sulfate, and concentrated under reduced pressure. The residue was purified by silica gel chromatography to obtained a compound (1-6) (155.6 g).

Compound (1-6)

¹H NMR (400 MHz, CDCl₃)

δ 0.21 (s, 6H), δ 1.00 (s, 9H), δ 1.75 (m, 4H), δ 2.66 (m, 4H), δ 6.50 (d, J=8.6 Hz, 1H), 7.23 (d, J=8.6 Hz, 1H).

Into a reaction vessel, 9-borabicyclo[3,3,1]nonane (39.2 g, 322 mmol) and 1,4-dioxane (1075 mL) were weighed under a nitrogen flow, and 1-octene (36.1 g, 322 mmol) was added and the mixture was stirred at 80° C. for 1 hour. Cesium fluoride (146.7 g, 966 mmol), [1,1′-bis(diphenylphosphino)ferrocene]dichloropalladium (II) (7.89 g, 9.66 mmol) and the compound (1-6) (109.8 g, 322 mmol) were added sequentially, and the mixture was stirred at 80° C. for 3 hours. The reaction mixture was poured into water (2.5 L), and extracted with ethyl acetate (1 L) three times. The organic layer was washed with saturated saline (1 L), then, dried over sodium sulfate, and concentrated under reduced pressure. The residue was purified by silica gel chromatography to obtain a compound (1-7) (49.8 g).

Compound (1-7)

¹H NMR (400 MHz, CDCl₃) δ 0.22 (s, 6H), δ 0.88 (t, 3H), δ 1.00 (s, 9H), δ 1.28 (m, 10H), δ 1.52 (m, 2H), δ 1.78 (m, 4H), δ 2.48 (m, 2H), δ 2.65 (m, 4H), δ 6.55 (d, 1H), δ 6.82 (d, 1H).

Into a reaction vessel, the compound (1-7) (49.8 g, 134 mmol) and N,N-dimethylformamide/water mixed solvent (volume ratio is 10/1, 150 mL) were weighed under a nitrogen flow, and cesium carbonate (21.8 g, 67 mmol) was added and the mixture was stirred at 100° C. for 1.5 hours. To the reaction solution was added water (450 mL), and extracted with methyl t-butyl ether (300 mL) twice. The organic layer was washed with saturated saline (200 mL), then, dried over sodium sulfate, and concentrated under reduced pressure. The residue was purified by silica gel chromatography to obtain a compound (1-8) (30.8 g).

Compound (1-8)

¹H NMR (400 MHz, CDCl₃)

δ 0.88 (t, 3H), δ 1.32 (m, 10H), δ 1.51 (m, 2H), δ 1.79 (m, 4H), δ 2.48 (m, 2H), δ 2.66 (m, 4H), δ 4.53 (d, 1H), 66.58 (d, 1H), δ 6.86 (d, 1H).

Into a reaction vessel, the compound (1-8) (61.2 g, 235 mmol) and pyridine (120 mL) were weighed under a nitrogen flow, and trifluoromethanesulfonic anhydride (73.6 g, 261 mmol) was dropped under cooling with ice. After dropping, the mixture was stirred at room temperature for 23 hours. The reaction solution was poured into water (300 mL), and extracted with methyl t-butyl ether (150 mL) twice. The organic layer was washed with 1 N hydrochloric acid (100 mL) three times and with saturated saline (200 mL) once, then, dried over sodium sulfate, and concentrated under reduced pressure. The residue was purified by silica gel chromatography to obtain a compound (1-9) (80.7 g).

Compound (1-9)

¹H NMR (400 MHz, CDCl₃)

δ 0.89 (t, 3H), δ 1.32 (m, 10H), δ 1.52 (m, 2H), δ 1.80 (m, 4H), δ 2.52 (m, 2H), δ 2.70 (m, 2H), δ 2.79 (m, 2H), δ 7.01 (m, 2H).

Into a reaction vessel, potassium acetate (61.5 g, 626 mmol), bis(pinacolate)diboron (58.3 g, 230 mmol), 1,1′-bis(diphenylphosphino)ferrocene (3.47 g, 6.26 mmol), [1,1′-bis(diphenylphosphino)ferrocene]dichloropalladium (II) (5.1 g, 6.26 mmol), compound (1-9) (78.2 g, 209 mmol) and 1,4-dioxane (1260 mL) were weighed under a nitrogen flow, and the mixture was stirred at 80° C. for 24 hours. The reaction solution was diluted with toluene (2 L), and washed with saturated saline (1 L) twice, then, dried over sodium sulfate, and concentrated under reduced pressure. The residue was purified by silica gel chromatography to obtain a compound (1-10) (37.6 g).

Compound (1-10)

¹H NMR (400 MHz, CDCl₃)

δ 0.88 (t, 3H), δ 1.28 (m, 10H), δ 1.32 (s, 12H), δ 1.54 (m, 2H), δ 1.77 (m, 4H), δ 2.54 (m, 2H), δ 2.69 (m, 2H), δ 3.05 (m, 2H), δ 6.97 (d, 1H), δ 7.56 (d, 1H).

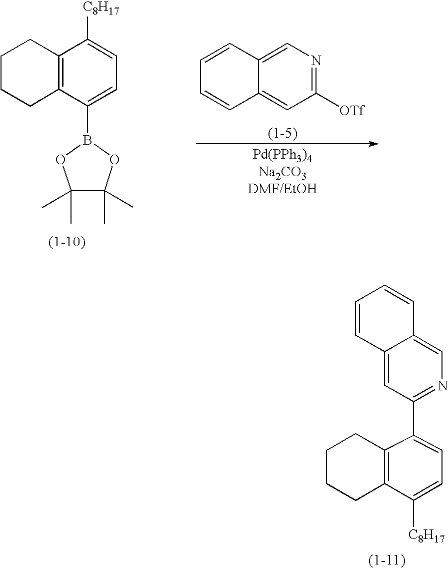

Into a reaction vessel was added the compound (1-5) (2.77 g, 10 mmol), compound (1-10) (3.94 g, 10 mmol), sodium carbonate (4.24 g, 40 mmol), N,N-dimethylformamide (100 mL), ethanol (10 mL) and tetrakis(triphenylphosphine)palladium (0) (0.58 g, 0.5 mmol) under a nitrogen flow, and the mixture was stirred at 115° C. for 8 hours. To the reaction solution was added water (400 mL) and ethyl acetate/hexane mixed solvent (volume ratio is 1/1, 400 mL) and extracted. The organic layer was washed with water (400 mL), 5 wt % sodium carbonate aqueous solution (300 mL) and saturated saline (100 mL), then, dried over sodium sulfate, and concentrated under reduced pressure. The residue was purified by silica gel chromatography to obtain a compound (1-11) (1.42 g).

Compound (1-11)

LC-MS (positive) m/z: 372 ([M+H]⁺)

¹H NMR (300 MHz, CDCl₃)

δ 0.89 (t, 3H), δ 1.30 (br, 10H), δ 1.61 (m, 2H), δ 1.71 (m, 2H), δ 1.85 (m, 2H), δ 2.62 (m, 2H), δ 2.79 (m, 4H), δ 7.10 (d, 1H), δ 7.20 (d, 1H), δ 7.60 (m, 1H), δ 7.70 (m, 2H), δ 7.83 (d, 1H), δ 8.00 (d, 1H), δ 9.31 (s, 1H).

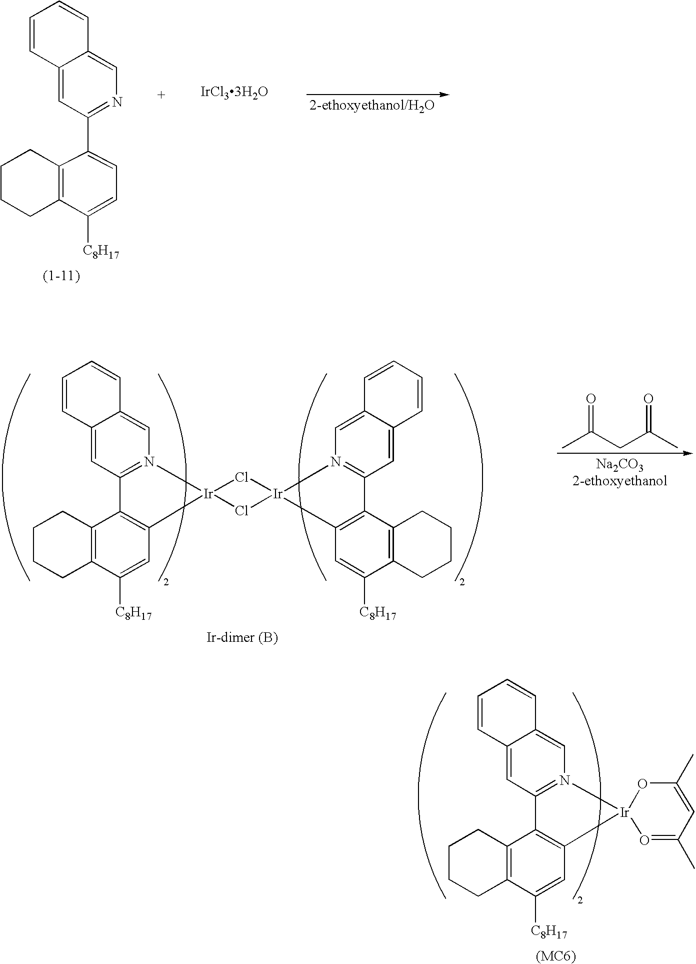

Into a reaction vessel, the compound (1-11) (592 mg, 1.5 mmol), iridium chloride trihydrate (241 mg, 0.68 mmol), 2-ethoxyethanol (3 mL) and water (1 mL) were weighed, and under a nitrogen flow, the mixture was heated at 140° C. for 16 hours. After air-cooling, the resultant reaction product was separated by filtration, and washed with water, methanol and hexane in this order, to obtain Ir-dimer (B) (475 mg, 0.25 mmol) as orange solid.

Into a reaction vessel, Ir-dimer (B) (388 mg, 0.20 mmol), acetylacetone (100 mg, 1.0 mmol), sodium carbonate (212 mg, 2.0 mmol) and 2-ethoxyethanol (6 mL) were weighed, and under a nitrogen flow, the mixture was stirred at 100° C. for 10 hours. The solvent was distilled off, the residue was purified by silica gel column chromatography, and the oily residue was washed with hexane and methanol, to obtain a metal complex (MC6) (133 mg, 0.13 mmol, yield: 32%).

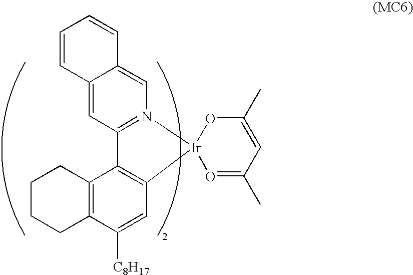

Metal Complex (MC6)

LC-MS (positive) m/z: 1033 ([M+H]⁺)

¹H NMR (300 MHz, CDCl₃)

δ 0.85-1.27 (m, 30H), δ 1.73 (m, 4H), δ 1.79 (s, 6H), δ 1.84 (m, 4H), δ 2.10 (m, 4H), δ 2.51 (m, 4H), δ 3.29 (m, 4H), δ 5.18 (s, 1H), δ 5.74 (s, 2H), δ 7.51 (dd, 2H), δ 7.66 (dd, 2H), δ 7.84 (d, 2H), δ 7.92 (d, 2H), δ 8.38 (s, 2H), δ 9.35 (s, 2H).

### —Measurement of Photoluminescence Quantum Yield—

Photoluminescence was measured in the same manner as in Example 4 excepting that the above-described metal complex (MC6) was used instead of the metal complex (MC5) in Example 4, to observe light emission having peaks at 575 nm, 615 nm, and the photoluminescence quantum yield was 46%.

### —Manufacturing of EL Device and Evaluation of Properties—

A 0.8 wt % chloroform solution was prepared of a mixture obtained by mixing CBP described in Example 4 and the metal complex (MC6) at a weight ratio of 97.5:2.5.

Next, on a glass substrate carrying an ITO film formed thereon with a thickness of 150 nm by a sputtering method, a solution of poly(ethylenedioxythiophene)/polystyrenesulfonic acid (Bayer Corp., trade name: Baytron P) was spin-coated to form a film with a thickness of 50 nm, and dried at 200° C. for 10 minutes on a hot plate. Then, the chloroform solution prepared as described above was spin-coated at a revolution of 3500 rpm to form a film. Further, this was dried at 130° C. for 1 hour under a nitrogen gas atmosphere, then, as a cathode, barium was vapor-deposited with a thickness of about 5 nm, then, aluminum was vapor-deposited with a thickness of about 80 nm, to produce an EL device. Here, after the degree of vacuum reached 1×10⁻⁴ Pa or less, vapor-deposition of a metal was initiated.

By applying voltage on the resultant EL device, EL light emission was observed having a maximum peak at 605 nm. This EL device manifested an emission luminance of about 100 cd/m² at about 18 V, and the maximum light emission efficiency thereof was 6 cd/A.

### EXAMPLE 6

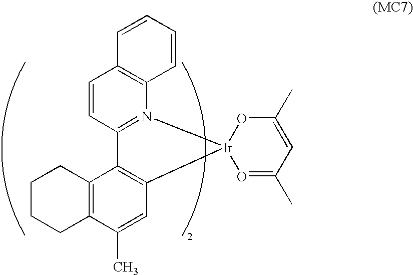

### —Calculation of Parameter—

According to the same manner as in Example 1, the dihedral angle (°) in a ligand of the above-described metal complex (MC7), and the d orbital parameter F (%/eV) thereof were calculated. As a result, the dihedral angle in a ligand was 12 (O), and the d orbital parameter F was 228.77 (%/eV).

### INDUSTRIAL APPLICABILITY

The metal complex of the present invention is extremely excellent in light emission efficiency and stability when applied, particularly in a light emitting material to be used in a light emitting layer of an electroluminescence device. This metal complex is usually luminous. These excellent properties are obtained not only in the red light emission region and the blue light emission region but also in the green light emission region. Therefore, this metal complex is particularly useful for production of light emitting devices such as an electroluminescence device and the like, and devices such as a photoelectric device and the like.

1. A metal complex having a structure of the following general formula (1): 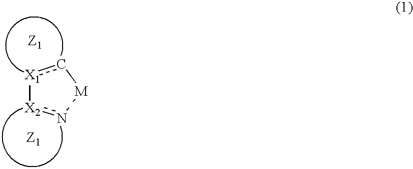
wherein, X₁ and X₂ represent each independently a carbon atom or nitrogen atom. A bond of the following formula: 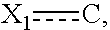
and a bond of the following formula: 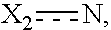
represent each independently a single bond or double bond, M represents a transition metal atom, Z₁ ring represents a cyclic structure containing a bond of the following formula: 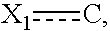
Z₂ ring represents a cyclic structure containing a bond of the following formula: 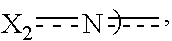
wherein
a dihedral angle defined by a plane containing a structure of the following formula: 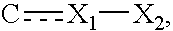
and a plane containing a structure of the following formula: 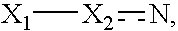
is 9° to 16°, and the proportion (%) of the sum of squares of orbital coefficients of the outermost d orbital of the metal atom M, in the highest occupied molecular orbital of the metal complex, occupying with respect to the sum of squares of all atom orbital coefficients, is divided by an energy difference S₁−T₁ between the lowest excitation singlet energy S₁ (eV) and the lowest excitation triplet energy T₁ (eV) of the metal complex, to give a value of 200 to 600%/eV.

2. A metal complex having a structure of the following general formula (1): 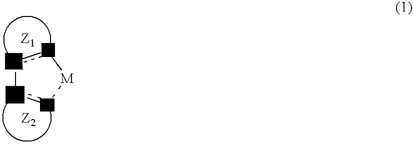
wherein, X₁ and X₂ represent each independently a carbon atom or nitrogen atom, a bond of the following formula: 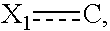
and a bond of the following formula: 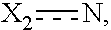
represent each independently a single bond or double bond, M represents a transition metal atom, Z₁ ring represents a cyclic structure containing a bond of the following formula: 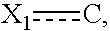
Z₂ ring represents a cyclic structure containing a bond of the following formula: 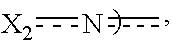
wherein
the above-described Z₁ ring has a structure of the following general formula (2): 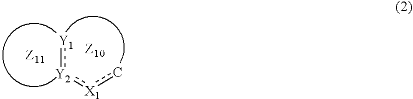
wherein, X₁, Y₁ and Y₂ represent each independently a carbon atom or nitrogen atom, a bond of the following formula: 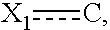
a bond of the following formula: 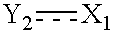
and a bond of the following formula: 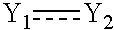
represent each independently a single bond or double bond, Z₁₀ ring represents a cyclic structure containing a structure of the following formula: 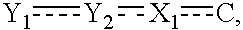
Z₁₁ ring represents a cyclic structure constituted of single bonds excepting the bond of the following formula: 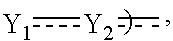
or the above-described Z₂ ring has a structure of the following general formula (3): 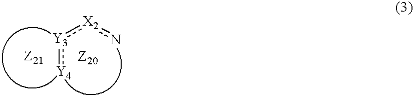
wherein, X₂, Y₃ and Y₄ represent each independently a carbon atom or nitrogen atom, a bond of the following formula: 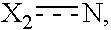
a bond of the following formula: 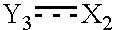
and a bond of the following formula: 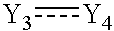
represent each independently a single bond or double bond, Z₂₀ represents a cyclic structure containing a structure of the following formula: 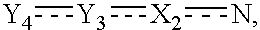
Z₂₁ ring represents a cyclic structure constituted of single bonds excepting the bond of the following formula: 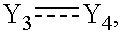
or, the above-described Z₁ ring has a structure of the general formula (2) and the above-described Z₂ ring has a structure of the general formula (3).

3. The metal complex according to claim 1, having a structure of the following general formula (4-1) or the following general formula (4-2): 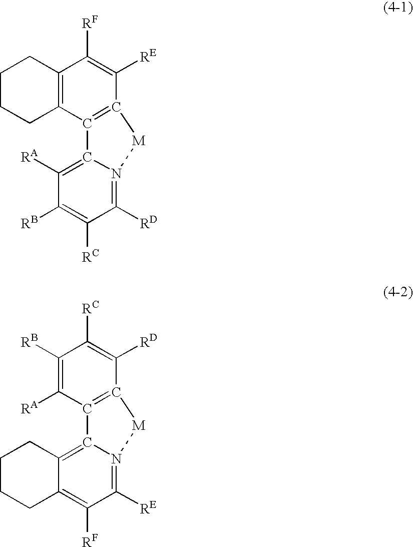
wherein, M represents the same meaning as described above, and R^{A}, R^{B}, R^{C}, R^{D}, R^{E} and R^{F} represent each independently a hydrogen atom, halogen atom, alkyl group, alkoxy group, alkylthio group, aryl group, aryloxy group, arylthio group, arylalkyl group, arylalkoxy group, arylalkylthio group, acyl group, acyloxy group, amide group, acid imide group, imine residue, substituted amino group, substituted silyl group, substituted silyloxy group, substituted silylthio group, substituted silylamino group, monovalent heterocyclic group, heteroaryloxy group, heteroarylthio group, arylalkenyl group, arylethynyl group, substituted carboxyl group or cyano group, alternatively, at least one combination selected from the group consisting of R^{A} and R^{B}, R^{B} and R^{C}, R^{C} and R^{D}, and R^{E} and RF may perform connecting to form an aromatic ring.)

4. A metal complex having a structure of the following general formula (5): 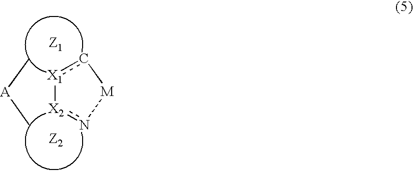
(wherein, X₁ and X₂ represent each independently a carbon atom or nitrogen atom, A bond of the following formula: 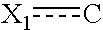
and a bond of the following formula: 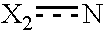
represent each independently a single bond or double bond, M represents a transition metal atom, Z₁ ring represents a cyclic structure containing a bond of the following formula: 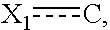
Z₂ ring represents a cyclic structure containing a bond of the following formula: 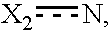
A represents a connecting group connected to one atom in the Z, ring and to one atom in the Z₂ ring, and the connecting group contains 2 to 6 groups selected from groups represented by —C(R⁵⁰¹)(R⁵⁰²)—, —N(R⁵⁰³)—, —P(R⁵⁰⁴)—, —P(═O)(R⁵⁰⁷)—, —Si(R⁵⁰⁵)(R⁵⁰⁶)— and SO₂, R⁵⁰¹ to R⁵⁰⁷ represent each independently a hydrogen atom, alkyl group, alkoxy group, alkylthio group, aryl group, aryloxy group, arylthio group, arylalkyl group, arylalkoxy group, arylalkylthio group, arylalkenyl group, aryl alkynyl group, amino group, substituted amino group, silyl group, substituted silyl group, silyloxy group, substituted silyloxy group, monovalent heterocyclic group or halogen atom.)

5. The metal complex according to claim 2, wherein the proportion (%) of the sum of squares of orbital coefficients of the outermost d orbital of the metal atom M, in the highest occupied molecular orbital of the metal complex, occupying with respect to the sum of squares of all atom orbital coefficients, is 33.3% or more.

6. The metal complex according to claim 2, wherein a dihedral angle defined by a plane containing a structure of the following formula: 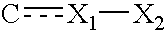
and a plane containing a structure of the following formula: 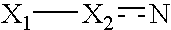
is 9° to 16°, and the proportion (%) of the sum of squares of orbital coefficients of the outermost d orbital of the metal atom M, in the highest occupied molecular orbital of the metal complex, occupying with respect to the sum of squares of all atom orbital coefficients, is divided by an energy difference S₁−T₁ between the lowest excitation singlet energy S₁ (eV) and the lowest excitation triplet energy T₁ (eV) of the metal complex, to give a value of 200 to 600%/eV.

7. The metal complex according to claim 1, wherein said M is a metal atom of ruthenium, rhodium, palladium, osmium, iridium or platinum.

8. A polymer compound comprising in its molecule a residue of the metal complex according to claim 1.

9. The polymer compound according to claim 8, wherein the polymer compound is a conjugated polymer compound.

10. The polymer compound according to claim 8, wherein said polymer compound comprises a divalent aromatic group.

11. The polymer compound according to claim 10, wherein said divalent aromatic group is a phenylene group optionally having a substituent, a naphthylene group optionally having a substituent, a divalent heterocyclic group optionally having a substituent, a divalent aromatic amine group optionally having a substituent, or a group of the following general formula (6): 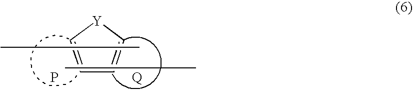
wherein, P ring and Q ring represent each independently an aromatic ring, but P ring may not be present, two connecting bonds are present on P ring and/or Q ring when P ring is present, and on a 5-membered ring or 6-membered ring containing Y and/or Q ring when P ring is not present, P ring, Q ring and 5-membered ring or 6-membered ring containing Y may each independently have at least one substituent selected from the group consisting of an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group and cyano group, Y represents —O—, —S—, —Se—, —B(R⁶)—, —Si(R⁷)(R⁸)—, —P(R⁹)—, —PR¹⁰ (═O)—, —C(R¹¹)(R¹²)—, —N(R¹³)—, —C(R¹⁴)(R¹⁵)—C(R¹⁶)(R¹⁷)—, —O—C(R¹⁸)(R¹⁹)—, —S—C(R²⁰)(R²¹)—, —N—C(R²²)(R²³)—, —Si(R²⁴)(R²⁵)—C(R²⁶)(R²⁷)—, —Si(R²⁸)(R²⁹)—Si(R³⁰)(R³¹)—, —C(R³²)═C(R³³)—, —N═C(R³⁴)— or —Si(R³⁵)═C(R³⁶)—, R⁶ to R³⁶ represent each independently a hydrogen atom, alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, silyloxy group, substituted silyloxy group, monovalent heterocyclic group or halogen atom.

12. A composition comprising the metal complex according to any claim 1 and/or the polymer compound comprising in its molecule a residue of the metal complex according to claim 1, a charge transporting material and/or a light emitting material.

13. A liquid composition comprising the metal complex according to claim 1 and/or the polymer compound comprising in its molecule a residue of the metal complex according to claim 1, and a solvent or dispersing medium.

14. A film comprising the metal complex according to claim 1 and/or the polymer compound comprising in its molecule a residue of the metal complex according to claim 1.

15. A device comprising the metal complex according to claim 1 and/or the polymer compound according to comprising in its molecule a residue of the metal complex according to claim 1.

16. A device having electrodes composed of an anode and a cathode, and a layer comprising the metal complex according to claim 1 and/or the polymer compound comprising in its molecule a residue of the metal complex according to claim 1.

17. The device according to claim 16, having electrodes composed of an anode and a cathode, and a charge transporting layer and/or a charge blocking layer.

18. A light emitting device comprising the device according to claim 15.

19. A switching device comprising the device according to claim 15.

20. A photoelectric conversion device comprising the device according to claim 15.

21. A sheet light source using the device according to claim 18.

22. An illumination using the device according to claim 18.

23. A display using the device according to claim 18.

24. A solar battery using the device according to claim 20.
